(19) United States
(12) Patent Application Publication
(10) Pub. No.: US 2026/0278954 A1
(43) Pub. Date: Sep. 17, 2026

(54) SYSTEM

(71) Applicant: SoftBank Group Corp., Tokyo (JP)

(72) Inventor: Ryoji ENOKI, Tokyo (JP)

(73) Assignee: SoftBank Group Corp., Tokyo (JP)

(21) Appl. No.: 19/551,658

(22) Filed: Feb. 27, 2026

Related U.S. Application Data
(60) Provisional application No. 63/772,914, filed on Mar. 17, 2025.

(51) Int. Cl. G06T 19/00; G06F 3/01; G10L 13/08; G10L 15/18; G10L 15/26

(52) U.S. Cl. CPC G06T 19/006; G06F 3/013; G06F 3/017; G10L 13/08; G10L 15/1822; G10L 15/26

(57) ABSTRACT

A system includes a processor that is configured to: control the display unit to superimpose information on a field of view of a user; control the voice input/output unit to receive voice input from the user; convert the received voice input into text; perform natural language processing on the text to analyze a question or consultation content of the user; generate an appropriate response based on a result of the analysis; control the voice input/output unit to output the generated response as voice output to the user; and control the display unit to display the generated response as text information, thereby enabling the user to interact with an artificial intelligence both visually and auditorily.

### CROSS-REFERENCE TO RELATED APPLICATION

This application is based on and claims priority under 35 USC 119(e) from U.S. Provisional Application No. 63/772,914 filed on Mar. 17, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for interacting with artificial intelligence typically rely on separate devices such as smartphones or computers, which require a user to divert visual attention away from the real-world environment and manually operate a screen or input device. In such systems, information is displayed on a dedicated screen that is not integrated into the user's natural field of view, and voice interaction, when provided, is often not synchronized with visual information in an intuitive manner. As a result, the user cannot smoothly obtain and confirm necessary information while continuously observing the surrounding environment, and the interaction with artificial intelligence tends to be fragmented and cognitively burdensome. Furthermore, known voice assistant systems usually process user utterances as discrete commands without sufficiently leveraging past dialogue histories or user-specific preferences. Consequently, these systems often fail to provide personalized responses that reflect each user's habits and interests, leading to a less natural and less engaging dialogue experience. In addition, typical display devices do not incorporate a gaze tracking function that detects a user's gaze direction in order to emphasize information of current interest. Even in systems that support augmented reality, information is generally positioned in a fixed or static manner that does not actively respond to where the user is looking. As a result, the user must deliberately move the gaze or perform additional operations to focus on particular information, which degrades usability and slows down access to necessary content.

Accordingly, there is a need for a system that enables a user to interact with artificial intelligence both visually and auditorily while maintaining a natural view of the real environment, that provides personalized responses based on past dialogue histories and user preferences, and that adaptively emphasizes and arranges information in the user's field of view based on gaze direction using augmented reality technology.

### SUMMARY

In order to solve the above-described problems, an aspect of the present invention provides a system comprising a processor, a display unit, and a voice input/output unit. The processor is configured to control the display unit to superimpose information on a field of view of a user so that digital information is visually integrated with the real-world scene observed by the user. The processor is further configured to control the voice input/output unit to receive voice input from the user, convert the received voice input into text, perform natural language processing on the text to analyze a question or consultation content of the user, and generate an appropriate response based on a result of the analysis. The processor is also configured to control the voice input/output unit to output the generated response as voice output to the user and to control the display unit to display the generated response as text information, thereby enabling the user to interact with artificial intelligence both visually and auditorily without looking away from the real environment.

In one preferred implementation, the processor is configured to analyze the voice input from the user in real time using a natural language processing algorithm to understand an intention of the user, and to refer to past dialogue histories of the user stored in association with the user. The processor is configured to generate a personalized response based on preferences or habits of the user inferred from the past dialogue histories. Through such configuration, the system provides more natural, context-aware, and individualized dialogue, enhancing the quality and continuity of interaction with the artificial intelligence.

In another preferred implementation, the processor is configured to control the display unit to detect a gaze direction of the user by a gaze tracking function, and to emphasize information that the user is currently gazing at, for example by changing size, brightness, or highlighting of displayed elements. The processor is further configured to adaptively arrange information provided from the processor in the field of view of the user by using augmented reality technology so as to improve visibility and relevance of the information in accordance with the user's gaze. By combining gaze tracking with adaptive augmented reality display, the system allows the user to quickly confirm necessary information simply by looking at it, thereby improving operability, reducing cognitive load, and enabling a seamless mixed visual and auditory interaction with artificial intelligence.

The term “system” refers to an arrangement of one or more hardware and software components that operate together to perform the functions described in the claims, including at least a processor, a display unit, and a voice input/output unit.

The term “processor” refers to one or more hardware processing circuits, such as a central processing unit (CPU), a graphics processing unit (GPU), a microcontroller, or any combination thereof, configured to execute instructions and control the operation of the display unit and the voice input/output unit as described in the claims.

The term “display unit” refers to a hardware component configured to present visual information to a user, including but not limited to a head-mounted display, a transparent or semi-transparent display, a projection display, or any other device that can visually superimpose digital information on a user's field of view.

The term “voice input/output unit” refers to a component or combination of components configured to receive voice input from a user and to provide voice output to the user, including at least a microphone for capturing sound and a speaker, earphone, bone-conduction transducer, or other audio output device.

The term “field of view of a user” refers to the region of the real-world environment that is visually perceived by the user at a given time, as seen through or around the display unit when the user is wearing or using the system.

The term “superimpose information” refers to causing visual information, such as text, icons, images, or graphical elements, to be displayed in a manner that appears overlaid on or integrated with the real-world scene in the user's field of view.

The term “voice input” refers to audio signals generated by speech of the user and captured by the voice input/output unit for processing by the processor.

The term “voice output” refers to audio signals generated or controlled by the processor and reproduced by the voice input/output unit for perception by the user as synthesized speech or other audio.

The term “text” refers to a sequence of characters, symbols, or words in one or more human languages that represent information derived from or used for natural language processing and display.

The term “natural language processing” refers to a set of computational techniques executed by the processor to analyze, interpret, and handle text or speech expressed in a human language, including but not limited to intent recognition, entity extraction, and language understanding.

The term “question or consultation content of the user” refers to semantic content of a user's utterance, including queries, requests, instructions, or other forms of spoken input seeking information, advice, or action.

The term “appropriate response” refers to information, explanations, recommendations, or other content generated by the processor that is determined to be relevant to and consistent with the analyzed question or consultation content of the user.

The term “text information” refers to visual content comprising one or more textual elements, such as words, phrases, sentences, or symbols, presented on the display unit to convey part or all of the generated response.

The term “past dialogue histories” refers to records of previous interactions between the user and the system, including but not limited to past user utterances, recognized text, detected intents, system responses, and timing information, stored in association with the user.

The term “preferences or habits of the user” refers to characteristics of the user's behavior, choices, and tendencies inferred from past dialogue histories or other user data, such as frequently requested topics, favored options, language style, or interaction patterns.

The term “personalized response” refers to an appropriate response that is generated by the processor while taking into account preferences or habits of the user, so that the content, style, or level of detail is adapted to the specific user.

The term “gaze direction” refers to an orientation or vector corresponding to where the user's eyes are directed, as determined by a gaze tracking function based on eye movement, head pose, or related biometric information.

The term “gaze tracking function” refers to hardware and software mechanisms configured to detect or estimate the gaze direction of the user, including but not limited to eye-tracking sensors, cameras, and associated processing algorithms.

The term “emphasize information” refers to modifying a visual representation of a portion of displayed information, such as by changing size, color, brightness, contrast, position, or other visual attributes, to make that portion more prominent or noticeable to the user.

The term “augmented reality technology” refers to techniques and systems for overlaying or integrating virtual objects, information, or graphical elements with a real-world environment in real time, so that the user perceives both real and virtual content within the same field of view.

The term “adaptively arrange information” refers to dynamically determining, by the processor, positions, layouts, and formats of displayed information within the user's field of view in response to context, such as the user's gaze direction, environment, or interaction state, to improve visibility or relevance.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

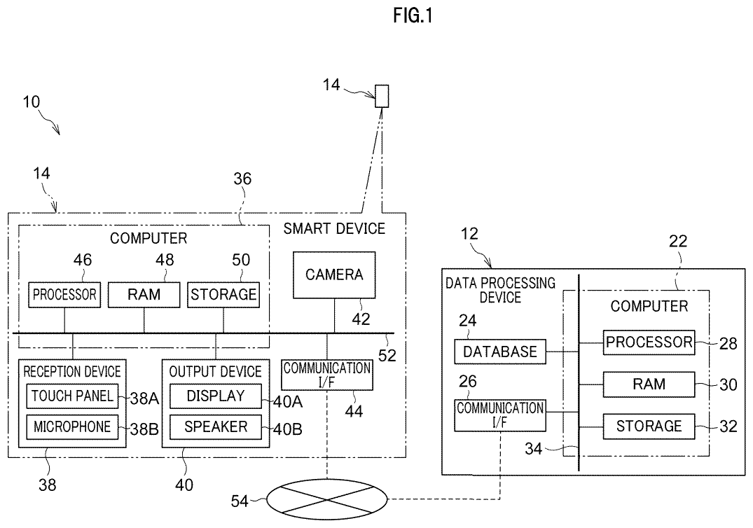

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

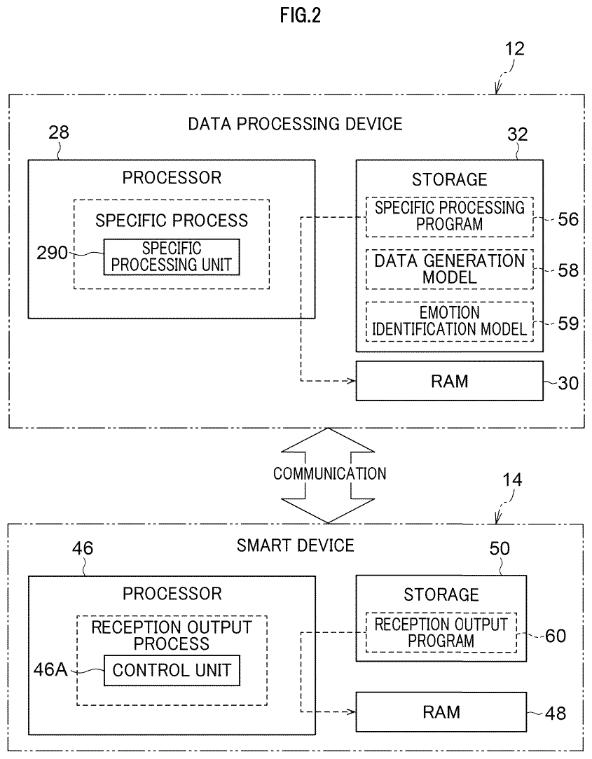

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional augmented-reality systems and conversational interfaces typically separate perception, natural language understanding, and content presentation into loosely coupled components that do not fully exploit context such as user gaze, spatial environment, and long-term interaction history. In many existing architectures, a client device merely captures audio and displays static overlays, while a remote server returns generic responses that are not structurally aligned with the spatial layout of the user's environment or with fine-grained indicators of user attention. As a result, the system often presents irrelevant or poorly prioritized information, requires excessive user input to refine results, and imposes unnecessary processing overhead due to redundant data transfers and unstructured response handling.

Furthermore, typical uses of generative artificial intelligence models rely on fixed or minimally parameterized prompts that do not systematically incorporate runtime signals such as gaze position, environment information, or evolving user preferences. This leads to suboptimal utilization of generative models, because the models are not guided by a rich, machine-curated context derived from sensor data and interaction logs. At the same time, client devices with limited processing resources are burdened with ad-hoc logic to filter and rearrange server responses for augmented-reality display, which increases latency, complicates software architecture, and can degrade the user experience.

There is therefore a need for an improved computer-implemented technique that tightly integrates sensor-rich client devices and a server-side generative artificial intelligence model. The technique should allow a processor to systematically (i) transform multimodal input signals, including audio, position, gaze, and environment information, into dynamically generated prompt sentences, (ii) post-process generative model outputs into structured display control data tailored for augmented-reality rendering, and (iii) continuously learn from interaction history to adapt both prompting and visual presentation. Such a technique should improve the efficiency and accuracy of server-side processing, reduce processing complexity on the client device, and enhance the relevance and usability of information presented to the user in real time.

The specific processing by the specific processing unit 290 of the data processing device 12 in Example 1 is realized by the following means.

The present invention provides a server comprising a processor configured to receive, from a client device, audio signals, gaze information, and environment information, to convert the audio signals into character information, to perform natural language processing on the character information to analyze utterance content of a user, to generate, based on an analysis result and usage state information derived from the gaze information, the environment information, and interaction history, a prompt sentence to be input to a generative artificial intelligence model, to request the generative artificial intelligence model to execute response generation processing using the prompt sentence, to post-process response information output from the generative artificial intelligence model by dividing the response information into information for audio output and information for visual output and generating structured display control data that is spatially associated with the environment information, and to update generation conditions of the prompt sentence and the display control data based on the interaction history including the response information and gaze positions. This enables an improved computer-implemented processing pipeline in which server-side prompting and response structuring are automatically optimized from multimodal context, thereby reducing client-side processing load, increasing the relevance and spatial coherence of augmented-reality presentations, and enhancing overall efficiency and technical performance of the underlying computing system.

The term “system” refers to a combination of hardware and software components that cooperate to perform processing for acquiring user input, executing artificial intelligence processing, and presenting information to a user.

The term “processor” refers to one or more hardware processing units, such as a central processing unit, a graphics processing unit, or a programmable logic device, configured to execute instructions to perform the data processing operations described herein.

The term “display device” refers to a hardware output device, such as a head-mounted transparent display or other visual presentation unit, configured to visually present information by superimposing the information on at least a portion of a user's field of view.

The term “acoustic device” refers to a hardware input/output device including at least one microphone and at least one sound output unit, configured to acquire audio signals representing user speech and to output audio signals representing system responses.

The term “position detection device” refers to any hardware and associated software configured to detect a spatial position, orientation, or movement of a user or a client device, including but not limited to a location sensor, an inertial sensor, or a satellite positioning receiver.

The term “gaze detection device” refers to any hardware and associated software configured to detect a line of sight or gaze position of a user relative to a display surface or a surrounding space, for example using image sensors and gaze estimation algorithms.

The term “external information acquisition device” refers to any component, including communication interfaces and software modules, configured to obtain environment information or other data from sources external to the processor, such as remote servers, databases, or sensors.

The term “audio signal” refers to electronic data representing sound, including analog or digital representations of speech captured by the acoustic device.

The term “character information” refers to textual data obtained by converting an audio signal into a sequence of characters or symbols corresponding to spoken words or phrases.

The term “natural language processing” refers to a set of computational techniques executed by the processor to analyze, interpret, or transform character information expressed in a human language, including operations such as tokenization, intent recognition, entity extraction, and dialogue management.

The term “utterance content” refers to semantic information representing what a user expresses in speech, including a user's request, question, instruction, or statement derived from the audio signal.

The term “usage state information” refers to contextual information indicating a current usage state of the system, including at least one of gaze information, position information, environment information, interaction history, or device status.

The term “prompt sentence” refers to a text or structured input sequence generated by the processor for controlling operation of a generative artificial intelligence model, the text or sequence including instructions, context, and user-related information.

The term “generative artificial intelligence model” refers to a trained computational model configured to generate text or other content based on an input prompt sentence, the model typically being implemented using a neural network architecture.

The term “response generation processing” refers to processing performed by the generative artificial intelligence model to produce response information in accordance with a prompt sentence, including selection and arrangement of words or data to form an output.

The term “response information” refers to data output by the generative artificial intelligence model in response to a prompt sentence, including at least textual content and optionally structured or unstructured auxiliary information.

The term “environment information” refers to information representing a physical or virtual environment around a user or device, including but not limited to location, spatial structure, nearby objects, points of interest, or sensor-derived context.

The term “post-processing” refers to processing performed by the processor on response information and environment information after execution of the generative artificial intelligence model, including transformation, filtering, partitioning, or formatting of the information.

The term “display control data” refers to structured data generated by the processor and used to control visual presentation on the display device, including layout parameters, spatial coordinates, emphasis attributes, and associations with environment information.

The term “information for audio output” refers to a portion of response information that is formatted or selected by the processor for presentation via an audio channel, such as text to be converted by a text-to-speech engine.

The term “information for visual output” refers to a portion of response information that is formatted or selected by the processor for presentation via a visual channel, such as text labels, icons, or graphical elements to be rendered on the display device.

The term “gaze position” refers to data indicating a location on the display device or in a visual scene at which the gaze detection device determines that the user is looking.

The term “augmented-reality display” refers to a mode of visual presentation in which virtual information is rendered by the display device in registration with or superimposed on a view of the real environment perceived by the user.

The term “interaction history” refers to stored data representing past interactions between the user and the system, including user utterances, system responses, gaze positions, environment information, and derived preference or behavior information.

The term “generation conditions” refers to parameters, rules, or context data used by the processor when generating a prompt sentence or display control data, including but not limited to user preferences, interaction history, and environment information.

The term “group of candidate objects” refers to a set of items or entities identified as potential targets for recommendation, explanation, or display, such as points of interest, content items, or selectable options, obtained from the generative artificial intelligence model or other data sources.

The term “spatial structure information” refers to data describing spatial relationships or geometry within an environment, including positions, orientations, distances, or topological relationships among objects or regions.

The term “display position” refers to a location, region, or coordinate on the display device at which visual information is to be rendered in accordance with the display control data.

The term “correspondence relationship” refers to an association established by the processor between two or more data elements, such as between a gaze position and a display position, or between a candidate object and a spatial location in the augmented-reality display.

In one embodiment, the system includes a server, a terminal, and a user. The server provides a processor, memory, and communication interfaces. The terminal provides a head-mounted display device, an acoustic device, a position detection device, and a gaze detection device. The user wears the terminal, and the terminal and the server cooperate to execute a computer program that implements the claimed functions.

The terminal uses hardware such as a head-mounted transparent display, a microphone array, bone-conduction speakers, an inertial measurement unit, a location sensor, and one or more eye-tracking cameras. The terminal runs an operating system, such as a mobile operating system, and an augmented-reality client application implemented for example with a three-dimensional graphics engine. The server uses hardware such as a multi-core central processing unit, one or more graphics processing units, and non-volatile storage, and runs a server operating system and application software including an automatic speech recognition engine, a natural language processing module, and a generative AI model execution module.

The terminal sends audio signals, gaze information, and environment information to the server. The server stores these signals in data structures in memory. In one example, the server stores the audio signal as a sequence of digital audio samples, the gaze information as pairs of screen coordinates and timestamps, and the environment information as records including position information and spatial structure information. The server converts the audio samples into character information using an automatic speech recognition engine. The server may use a neural-network based speech recognition engine with an encoder-decoder architecture, in which an acoustic encoder transforms the audio samples into dense feature vectors, and a decoder outputs characters or word pieces. The server then performs natural language processing on the character information with a text processing module that executes tokenization, part-of-speech tagging, and intent classification using a trained classifier.

The server generates a prompt sentence for a generative AI model. The server uses a prompt generation module that constructs the prompt sentence by concatenating several parts in memory: a system instruction, a context description, a representation of the user's utterance, and a task description. The server uses the character information, the gaze information, the environment information, and an interaction history stored in a database as inputs to this module. The interaction history may be stored as relational records containing fields such as a user identifier, utterance text, model response text, gaze positions, and environment snapshots. The server reads these records, computes derived features such as frequency of selection of particular object categories or preferred distance ranges, and encodes the features as textual descriptions in the prompt sentence.

In one specific implementation, the server generates a prompt sentence for a weather-related request as follows:
“User utterance: ‘What is the weather tomorrow?’
User location: Tokyo, Japan (35.68, 139.76).
User preference summary: The user prefers concise weather summaries with emphasis on precipitation.
External data: Current forecast for tomorrow at this location is available.
Task: Summarize tomorrow's weather including high and low temperature, chance of precipitation, and any severe weather warnings. Respond in simple English, suitable to be spoken aloud and briefly displayed in augmented reality.”
In another example, the server generates a prompt sentence for a nearby restaurant recommendation as follows:
“User utterance: ‘Show me recommended restaurants near here.’
User location: 35.6595, 139.7005.

User preference summary: The user often chooses mid-price, quiet cafes and restaurants with vegetarian options.

Candidate restaurants: A list of nearby restaurants with attributes such as distance, rating, price level, and tags is available.

Task: From the candidate restaurants, select the best three for this user, explain briefly why each one is recommended, and output the explanations in simple English for speech and augmented-reality display.”

In a sightseeing scenario, the server generates a prompt sentence for historical information as follows:

“The user is looking at a historical building identified as ‘Old City Hall’ in the current environment.

User utterance: ‘Tell me the history of this building.’

Background information: Historical text about the building including origin, important events, and cultural significance is available.

Task: Using the background information, generate an engaging yet concise historical overview in English, suitable to be read aloud in about one to two minutes and summarized next to the building in augmented reality.”

The server executes a generative AI model using the prompt sentence. In one embodiment, the server uses a transformer-based neural network with an encoder-decoder or decoder-only architecture. The model includes multiple attention layers, feed-forward layers, and layer normalization components. The server represents the prompt sentence as a sequence of tokens by using a subword tokenizer. The server maps the tokens to embedding vectors and supplies them to the model. The server runs matrix multiplications and attention computations on a graphics processing unit using numerical libraries such as a linear algebra library. The server sets generation parameters such as maximum output length, sampling temperature, and nucleus sampling probability. The generative AI model outputs response information as a sequence of tokens, which the server converts back to character information.

The server performs post-processing on the response information and the environment information. The server uses a response processing module that parses the text output into segments for audio and for visual display. In one example, the server splits the text into a short summary sentence for a head-up overlay and a longer body for detailed audio description. The server further derives structured display control data from the response. The display control data can include fields for display position, visual emphasis attributes, and spatial associations. For instance, when the response includes three recommended restaurants, the server associates each restaurant with a world coordinate or a direction vector based on the environment information and the position detection device output. The server then creates display control records that include a label string, a distance value, and a target three-dimensional coordinate for each restaurant.

The server updates generation conditions of the prompt sentence and the display control data based on the interaction history. The server uses a learning module that analyzes past interaction records. The learning module computes statistical features such as how long the user gazed at particular items, how often the user accepted or ignored suggested objects, and which environmental contexts yielded high engagement. The server may train a recommendation model, such as a matrix factorization model or a shallow neural network, on these features. The server then converts the learned preferences into textual summaries or parameter settings that are embedded into future prompt sentences. The server also adjusts layout parameters in the display control data, for example by prioritizing positions that the user tends to view or by changing visual emphasis thresholds.

The terminal receives the display control data and the information for audio output from the server. The terminal converts the text for audio output into synthesized speech using a text-to-speech engine running on the terminal or on the server. The terminal sends the resulting audio samples to the bone-conduction speakers, allowing the user to hear the response even in noisy environments while maintaining awareness of ambient sounds. The terminal uses the display control data to render visual overlays on the head-mounted display device. The terminal reads the current head pose from the inertial measurement unit and fuses it with the position information from the position detection device to determine the orientation of the display relative to the environment. The terminal maps the three-dimensional coordinates in the display control data to screen positions and draws text labels, icons, or other graphical elements using the graphics rendering engine.

The terminal uses the gaze detection device to measure a gaze position on the display. The terminal compares the gaze position with the positions of displayed objects described in the display control data. If the user's gaze stays within a predetermined threshold distance of a specific object's display position for longer than a threshold time, the terminal determines that the object is being gazed at. The terminal then changes the visual rendering of the object, for example by increasing brightness, changing color, or expanding additional detailed text. The terminal also sends a gaze-focus event to the server including the object identifier, gaze position, and timestamp. The server records this event in the interaction history and uses it as feedback for later prompt sentence generation and personalization.

The server, by constructing the prompt sentence from multimodal context rather than using a fixed static prompt, improves computational efficiency and output quality of the generative AI model. The server reduces the volume of data sent to the generative AI model by performing pre-selection and summarization of environment information and interaction history. For example, instead of transmitting all past dialogues and all detected objects, the server selects only a small subset of relevant records and encodes them as brief textual descriptions. This reduces input length and inference time, and therefore increases processing speed. At the same time, the server improves accuracy because the prompt sentence includes explicit references to user preferences, active gaze targets, and spatial context, which guide the model to produce responses that match the actual situation and user intent.

The server uses specific internal data structures and algorithms that differ from human manual processing. For prompt generation, the server maintains a prompt template library and a rule engine. The rule engine selects a template based on an intent classification result and fills template slots with context values derived from sensor data and interaction logs. The rule engine may apply non-intuitive heuristics, such as ignoring environment information from sensors that have not changed beyond a numerical threshold, or emphasizing objects with a high gaze dwell time. These heuristics are implemented as conditional rules encoded in the program and are applied algorithmically. This processing is not a mere automation of human reasoning, because the server uses numerical thresholds and multi-dimensional features computed from sensor data that humans do not directly perceive or manually analyze.

The generative AI model itself is trained using a supervised learning or reinforcement learning scheme. The server or an offline training system uses a large corpus of text data consisting of question-answer pairs and domain-specific documents. The training process uses an objective function such as a cross-entropy loss between predicted tokens and target tokens. The training system updates model weights using a gradient-based optimization algorithm. The system may apply regularization techniques, such as dropout and weight decay, and data augmentation such as paraphrasing and context shuffling. During deployment, the server does not retrain the core model in real time, but may adjust small adapter layers or prompt-tuning vectors based on interaction statistics. The server thus uses a combination of fixed foundation model parameters and dynamically generated prompt sentences to tailor behavior without full retraining.

The system achieves technical improvements over conventional architectures. The server reduces communication load between the server and the terminal by sending structured display control data instead of raw or unstructured text for all objects. The display control data is compact and encoded with necessary rendering parameters, so the terminal can draw overlays without additional parsing or interpretation. This reduces processing on the terminal and lowers latency. The server improves data management by organizing interaction history in a format optimized for retrieval by the prompt generation and learning modules. The server uses indexed fields such as time, location, and object category to quickly select relevant records, which improves the speed of personalization.

The terminal, by offloading heavy natural language and generative processing to the server, can use a less powerful processor while still providing real-time augmented-reality output. The terminal focuses on sensor acquisition, low-level signal processing, and rendering. Because the display control data is already structured, the terminal does not execute complex reasoning or natural language analysis, which improves determinism and reduces error rates in visualization. The combination of gaze detection and environment-aware rendering leads to more efficient use of display area and reduces cognitive load for the user, because only objects that the user actually looks at are expanded and emphasized.

In a variant embodiment, the server may be co-located with the terminal, for example in a local processing unit attached to the head-mounted display. In another variant, the position detection device may be replaced or supplemented by visual-inertial odometry computed from camera images and inertial sensors. In yet another embodiment, the generative AI model may be distributed across multiple computing nodes, with a smaller local model executing on the terminal for simple tasks and a larger model executing on a remote server for complex explanations. In all of these embodiments, the core technique remains that the server or processing node constructs a prompt sentence using multimodal context, uses a generative AI model to obtain response information, post-processes the response into structured display control data, and updates generation conditions based on interaction history.

The system therefore provides a specific technical implementation that integrates a generative AI model with sensor-rich augmented-reality hardware. The server and the terminal cooperate through defined data structures, algorithms, and control flows that are designed to improve processing speed, accuracy, and resource usage, and are not limited to abstract mental steps or business logic. By tying the generation and presentation of information directly to concrete device states, sensor outputs, and learned technical parameters, the system achieves a concrete improvement in computer technology and human-machine interaction.

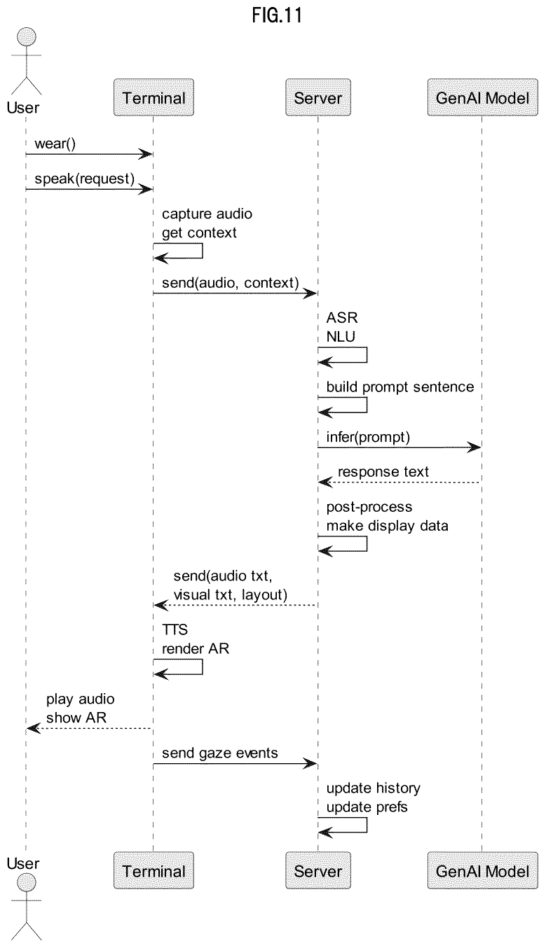

The following describes the processing flow using FIG. 11.

### Step 1:

The user wears the terminal.

The user positions the head-mounted display so that the transparent screen is in front of the eyes and the bone-conduction speakers are in contact with the head.

Input: No digital input.

Output: A physical state in which the terminal sensors (display, microphone, gaze cameras, position sensors) are correctly oriented relative to the user's head, enabling subsequent data acquisition.

### Step 2:

The terminal initializes hardware and software components.

The terminal boots the operating system, loads device drivers for the display device, acoustic device, position detection device, and gaze detection device, and starts an augmented-reality client application.

Input: Configuration data stored in non-volatile memory (device settings, network parameters, calibration data).

Output: Initialized hardware interfaces and a running client application with active sensor streams and network stack, represented in memory by handles to devices and communication sockets.

### Step 3:

The terminal establishes a communication session with the server.

The terminal uses its communication interface to open a secure channel to the server, performs authentication, and registers a session identifier.

Input: Network configuration (server address, authentication credentials) and communication protocols.

Output: A persistent logical session identified by a session ID, and a bidirectional encrypted channel ready to transmit audio, gaze, and environment data.

### Step 4:

The user issues a spoken request.

The user produces speech such as “What is the weather tomorrow?” or “Show me recommended restaurants near here.” near the microphone of the terminal.

Input: No digital input; physical speech waveform.

Output: An analog audio signal at the microphone terminals that encodes the user's utterance for subsequent digitization.

### Step 5:

The terminal captures and pre-processes the audio signal.

The terminal samples the analog microphone signals using an audio codec, converts them into digital samples, and applies noise reduction, echo cancellation, and automatic gain control. The terminal then encodes the processed samples into a compressed audio frame.

Input: Analog audio waveform from the microphone.

Output: A compressed digital audio buffer (for example, encoded frames) stored in memory, representing the cleaned user speech.

### Step 6:

The terminal acquires context information.

The terminal queries the position detection device for location and orientation, queries the gaze detection device for current gaze coordinates, and reads system time and user identity from local storage. The terminal aggregates these values into a context object.

Input: Sensor readings (GNSS or other location signals, inertial sensor data, camera images for gaze tracking), system clock value, user identifier.

Output: A structured context record containing at least location information, head pose, gaze position, timestamp, and user ID, stored in memory.

### Step 7:

The terminal transmits the request to the server.

The terminal packages the compressed audio buffer and the context record into a request message, assigns a request ID, and sends the message over the secure channel to the server.

Input: Compressed audio buffer, context record, and session information.

Output: A network packet stream delivered to the server that includes audio data, context data, session ID, and request ID.

### Step 8:

The server receives and validates the request.

The server reads the incoming network stream, reconstructs the request message, checks authentication and message integrity, and writes a copy of the raw request into a log store.

Input: Encrypted request packets containing audio data, context data, session ID, and request ID.

Output: A validated request object in server memory and a stored log record associating the user ID and request ID with the raw input.

### Step 9:

The server converts audio to character information.

The server decodes the compressed audio buffer into a digital waveform and feeds it into an automatic speech recognition engine. The engine computes spectral features (for example, Mel-frequency cepstral coefficients), passes them through a neural network, and outputs character or subword tokens. The server concatenates the tokens into a text string.

Input: Digital audio waveform reconstructed from the compressed audio.

Output: Character information in the form of a text string representing the recognized user utterance, associated with the request ID and stored in memory.

### Step 10:

The server performs natural language analysis and intent detection.

The server tokenizes the text string, applies part-of-speech tagging and syntactic parsing, and executes an intent classifier implemented as a trained model. The classifier uses feature vectors derived from the tokens to predict an intent label and associated entities such as dates, object types, or locations.

Input: Text string representing the recognized utterance and a set of trained intent classification parameters.

Output: An intent record containing an intent label (for example, “get weather”, “find restaurants”), extracted entities, and confidence scores, stored in an intermediate data structure.

### Step 11:

The server enriches the intent with context and history.

The server retrieves interaction history associated with the user ID from a database, including past utterances, responses, gaze focus events, and environment snapshots. The server computes user preference features such as frequently selected categories and preferred distance ranges, and merges these with the current context (location, gaze position).

Input: Intent record, context record, and interaction history records retrieved from persistent storage.

Output: An enriched context object that includes intent, entities, user preference summary, and derived numeric features, held in server memory.

### Step 12:

The server retrieves external environment data.

The server examines the intent and, if required, performs external API calls, for example to a weather service or a location service. The server sends queries containing location and time parameters, receives structured responses, and filters and normalizes the data.

Input: Enriched context object (including location and time) and configuration parameters for external APIs.

Output: A cleaned external data set, such as a normalized forecast record or a list of candidate points of interest, stored in a structured format for later use.

### Step 13:

The server constructs a prompt sentence for the generative AI model.

The server selects a template corresponding to the intent and fills predefined slots with values from the enriched context and the external data set. The server concatenates a system instruction, a description of user preferences, a restatement of the user utterance, and a task specification into a single text string.

Input: Enriched context object, external data set, and prompt template definitions.

Output: A prompt sentence text that encodes instructions, context, and data for the generative AI model, stored as a sequence of characters and tokens.

### Step 14:

The server executes the generative AI model to generate response information.

The server tokenizes the prompt sentence, converts tokens into embedding vectors, and supplies them to a transformer-based generative AI model. The model performs matrix multiplications and attention operations layer by layer to compute probability distributions over next tokens and samples or selects tokens to form an output sequence. The server converts the output tokens back into a text string.

Input: Prompt sentence tokens and model parameters (weights, biases, attention masks).

Output: Response information in the form of a generated text string and, optionally, structured annotations, stored in server memory.

### Step 15:

The server post-processes the response information for audio and visual output.

The server parses the generated text, segments it into a concise summary for on-screen display and a detailed explanation for speech, and identifies references to items such as places or objects.

The server maps these references to internal identifiers contained in the external data set or environment information.

Input: Generated text string and external data set or candidate object list.

Output: A partitioned response where one part is marked as “audio text” and another part is marked as “visual text” linked to specific objects, stored in a response structure.

### Step 16:

The server generates display control data.

The server uses environment information and positions of identified objects to compute spatial coordinates for each object relative to the user. The server assigns display positions, emphasis levels, and layout priorities, and organizes this information into structured display control records.

Input: Partitioned response structure, environment information, and object position data.

Output: Display control data that includes display positions, visual attributes, and associations between textual elements and environment objects, stored in a format ready for transmission.

### Step 17:

The server updates interaction history and personalization parameters.

The server writes the new utterance, the intent record, the prompt sentence, the generated response, and any known object associations into a history database. The server updates user preference statistics and, optionally, small tuning vectors used in prompt generation based on quantitative features such as gaze dwell time and selection frequency.

Input: Request ID, user ID, enriched context object, prompt sentence, response information, and display control data.

Output: Updated interaction history records and updated personalization parameters persisted in storage for use in future requests.

### Step 18:

The server sends the response package to the terminal.

The server encapsulates the audio text, the visual text, the display control data, and any additional metadata into a response message identified by the request ID and transmits it over the secure channel to the terminal.

Input: Audio text, visual text, display control data, and session/request identifiers.

Output: A serialized response packet delivered to the terminal via the communication channel.

### Step 19:

The terminal receives and parses the response package.

The terminal reads the incoming packets, reconstructs the response message, matches the request ID with the original request, and extracts the audio text, visual text, and display control data into local memory structures.

Input: Response packet received over the network.

Output: Parsed response components, including audio text string, visual text segments, and display control records, available for local rendering.

### Step 20:

The terminal synthesizes audio output.

The terminal passes the audio text to a text-to-speech engine, which converts characters into phoneme sequences and then into audio waveforms using concatenative or neural synthesis. The terminal may adjust speaking rate and volume based on user settings.

Input: Audio text string and text-to-speech configuration parameters.

Output: Digital audio samples representing synthesized speech, buffered for playback.

### Step 21:

The terminal plays the synthesized audio through the acoustic device.

The terminal sends the audio samples to the bone-conduction speakers via an audio driver, potentially applying equalization or volume limiting, so that the user hears the generated explanation or recommendation.

Input: Digital audio samples from the text-to-speech engine.

Output: Physical vibrations at the bone-conduction transducers that the user perceives as sound.

### Step 22:

The terminal computes current spatial pose and gaze alignment.

The terminal reads the latest position and orientation from the position detection device and the latest gaze coordinates from the gaze detection device. The terminal fuses these values to determine where, in the user's field of view, each environment object should be rendered according to the display control data.

Input: Position information, head orientation, gaze coordinates, and display control data.

Output: A mapping from environment objects and display control records to concrete display coordinates on the terminal's screen.

### Step 23:

The terminal renders augmented-reality visual elements.

The terminal uses its graphics engine to draw visual text, icons, and shapes at the computed display coordinates. The terminal applies emphasis attributes such as color, brightness, or size according to the display control data to differentiate more important items from less important ones.

Input: Visual text segments, computed display coordinates, and visual attributes from display control data.

Output: A rendered frame in the terminal's frame buffer, resulting in superimposed virtual information in the user's field of view.

### Step 24:

The terminal tracks gaze-based focus on displayed items.

The terminal continuously monitors the gaze coordinates over time and compares them with the display positions of rendered items. If the gaze remains within a threshold distance of a particular item for longer than a defined duration, the terminal determines that the item is in focus and changes the rendering to highlight it or reveal additional details.

Input: Time-stamped gaze coordinates and item display positions.

Output: Updated rendering states for focused items and, optionally, a focus event record specifying item identifier, gaze position, and focus duration.

### Step 25:

The terminal sends gaze-focus events back to the server.

The terminal packages one or more focus event records and transmits them to the server as feedback associated with the user ID and request ID.

Input: Focus event records generated from gaze tracking.

Output: A feedback message delivered to the server and ready to be consumed by the server's learning and history-updating modules.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional interactive systems that combine a display, an audio input/output interface, and a software agent typically treat speech recognition, natural language understanding, and response presentation as loosely coupled components. In many cases, a generic language model is invoked with ad-hoc text input, without systematic construction of machine-oriented prompt sentences that reflect real-time sensor data, user gaze, and domain-specific context. As a result, such systems often produce generic, context-insensitive responses, and they fail to exploit available structured data, such as biological measurements, behavioral histories, or external instructions from professional organizations.

Furthermore, existing caregiving support systems usually handle sensor monitoring, alert detection, and communication with external entities as separate functions. They do not tightly integrate these functions with the natural language interaction loop. For example, abnormal biological information may trigger a visual or audible alarm, but it is not automatically transformed into an updated, context-aware prompt sentence for a generative artificial intelligence model. This separation limits the system's ability to generate adaptive, safety-aware guidance and to update instructions dynamically in response to changing conditions.

In addition, conventional augmented reality interfaces and eye-tracking techniques are mostly used for user interface enhancement, such as pointer control or simple highlighting of on-screen elements. They do not use gaze information as a first-class input to a backend prompt-generation pipeline. Consequently, such systems do not exploit the user's gaze focus to derive implicit intent, nor do they inject gaze-derived identifiers into the prompt sentences supplied to a generative artificial intelligence model. This underutilization reduces the precision and relevance of generated content, especially in environments where the user's attention is rapidly shifting among multiple physical and virtual objects.

From a computer technology standpoint, there is a need for a technical architecture in which a processor manages multimodal inputs (audio, gaze, sensor streams), constructs machine-interpretable prompt sentences with structured context, and orchestrates generative artificial intelligence processing in a deterministic, verifiable manner. Existing architectures often treat the generative model as a black box with free-form input and output, which complicates safety validation, logging, and reproducibility. In mission-critical scenarios such as health-related support, this lack of structured orchestration can lead to unpredictable behavior and hinder integration with downstream systems such as professional organization information systems.

Accordingly, an improved computer-implemented system is required that: (i) continuously collects and analyzes biological information in real time; (ii) detects abnormal states; (iii) encodes user intent, real-time sensor context, historical records, and gaze-derived focus into structured prompt sentences; (iv) supplies those prompt sentences to a generative artificial intelligence model; and (v) presents multimodal responses via an augmented display and an audio interface in a way that is traceable and controllable. Such a system would not merely automate manual tasks but would improve the functioning of the computer system itself by optimizing data flow, state management, prompt construction, and response orchestration across multiple hardware and software components.

The specific processing by the specific processing unit 290 of the data processing device 12 in Application Example 1 is realized by the following means.

The present invention provides a server comprising a processor and a memory storing instructions that, when executed by the processor, cause the server to control a display unit, an audio input/output unit, and an artificial intelligence processing unit in communication with a user device; to receive audio data corresponding to user speech from the audio input/output unit and convert the audio data into character data; to perform natural language processing on the character data to determine a user intention; to acquire context information including attribute information of a subject person, biological information of the subject person, behavioral history information of the subject person, and medical-related information of the subject person from one or more data stores; to generate, based on the user intention and the context information, a structured prompt sentence configured for input to a generative artificial intelligence model; to transmit the structured prompt sentence to the generative artificial intelligence model and obtain a response sentence generated by the generative artificial intelligence model; to generate response information including character information and graphic information, and audio information, based on the response sentence; to provide the response information to the display unit and the audio input/output unit for superimposed visual presentation and audible output; to receive biological information streams from at least one sensing device, detect an abnormal state of the subject person based on the biological information by executing a rule-based or statistical algorithm, and generate warning information corresponding to the abnormal state for output via the display unit and the audio input/output unit; to receive gaze information indicating a gaze direction of the user from an eye-tracking component of the user device, to determine a display region or object corresponding to a gaze target, to emphasize information associated with the display region or object on the display unit, and to modify the structured prompt sentence such that additional information related to the gaze target is embedded as part of the input to the generative artificial intelligence model; and to transmit the biological information and related context information of the subject person to an external professional organization system based on the detected abnormal state or based on the gaze target, to receive instruction information from the external professional organization system, and to incorporate the instruction information into the response information for presentation to the user. This enables an integrated, computer-implemented workflow in which multimodal inputs are fused into machine-interpretable prompt sentences, generative artificial intelligence processing is orchestrated in a structured and auditable manner, and context-adaptive responses are delivered through augmented reality and audio channels, thereby improving the technical performance, reliability, and usability of the interactive support system.

The term “display unit” refers to an output component configured to visually present information to a user, including a configuration that superimposes character information and graphic information within the user's field of view, for example by using an optical see-through or video see-through mechanism.

The term “audio input/output unit” refers to an input/output component configured to acquire audio signals from a user, such as spoken utterances, and to provide audio signals to the user, such as synthesized speech or alert sounds, using one or more microphones and one or more sound reproduction devices.

The term “artificial intelligence processing unit” refers to a processing component, implemented by hardware, software, or a combination thereof, that executes one or more algorithms for converting audio data into character data, performing natural language processing, interacting with a generative artificial intelligence model, and generating response information.

The term “processor” refers to one or more hardware processing circuits, such as a central processing unit, a graphics processing unit, or a digital signal processor, configured to execute instructions to perform operations including data acquisition, data analysis, prompt generation, communication control, and response presentation.

The term “memory” refers to one or more non-transitory storage media, such as semiconductor memory, magnetic storage, or optical storage, configured to store instructions and data for use by the processor.

The term “character data” refers to a digital representation of textual information obtained by converting audio data, symbols, or other inputs into sequences of characters or tokens suitable for natural language processing and display.

The term “natural language processing” refers to computational techniques for analyzing, interpreting, and transforming human language expressed as character data, including at least one of tokenization, part-of-speech tagging, parsing, intent classification, and entity extraction.

The term “user intention” refers to a semantic representation of a purpose or request expressed by the user, determined by processing character data with natural language processing techniques, and used as a basis for selecting a processing path or generating a prompt sentence.

The term “subject person” refers to an individual whose state is monitored or managed by the system, and for whom biological information, behavioral history information, and medical-related information are collected and used as context information.

The term “attribute information of a subject person” refers to static or relatively slowly changing data about the subject person, such as age, sex, known conditions, and general profile attributes.

The term “biological information” refers to time-varying physiological or health-related measurement data associated with the subject person, including at least one of heart rate, blood pressure, body temperature, respiratory rate, and similar vital signs.

The term “behavioral history information” refers to data representing past actions or activities of the subject person, such as movement patterns, exercise records, daily routines, and task completion logs.

The term “medical-related information” refers to information associated with medical care of the subject person, including at least one of medication schedules, prescribed dosages, treatment plans, clinical notes, allergy information, and recorded instructions from professional organizations.

The term “context information” refers to a collection of data related to a current interaction, including attribute information of the subject person, biological information, behavioral history information, medical-related information, and optionally environmental data and user interaction history.

The term “prompt sentence” refers to a structured text string or set of text strings generated by the system for input to a generative artificial intelligence model, the structured text including at least a representation of user intention and context information.

The term “generative artificial intelligence model” refers to a machine-implemented model that has been trained to produce text or other content in response to input data, and that generates a response sentence when supplied with a prompt sentence.

The term “response sentence” refers to text generated by the generative artificial intelligence model based on a prompt sentence, the text being intended for further processing and presentation to the user.

The term “response information” refers to information derived from a response sentence and structured for presentation through one or more modalities, including character information, graphic information, and audio information.

The term “warning information” refers to information generated when an abnormal state of the subject person is detected, the information indicating at least a type of abnormality, a level of urgency, and optionally one or more recommended actions.

The term “abnormal state” refers to a condition of the subject person detected by analyzing biological information with a rule-based algorithm, a statistical algorithm, or another computational method, the condition indicating that at least one measured value deviates from a predetermined normal range or pattern.

The term “eye-tracking component” refers to a hardware and software configuration that detects movement and orientation of at least one eye of the user in order to estimate a gaze direction or point of regard relative to a display region or real-world scene.

The term “gaze direction” refers to a direction or point determined by the eye-tracking component as representing where the user is looking within a display region or toward a physical object.

The term “gaze target” refers to a display region, display element, or physical object that is determined by correlating the gaze direction with known positions of elements or objects.

The term “display region” refers to a defined area within the display unit in which information is presented, including windows, panels, icons, and graphical overlays.

The term “display element” refers to an identifiable unit of visual content within a display region, such as a text label, button, icon, image, or augmented reality overlay.

The term “emphasize information” refers to modifying the presentation of information on the display unit, for example by changing size, color, brightness, or position, to increase the visual prominence of that information relative to other information.

The term “template information” refers to pre-defined structural patterns or text fragments used as a basis for constructing prompt sentences, the patterns being combined with context information to produce a machine-interpretable input for the generative artificial intelligence model.

The term “storage unit” refers to one or more storage resources, including memory or external storage devices, configured to store character data, interaction histories, biological information histories, behavioral histories, warning histories, and template information for retrieval by the processor.

The term “past interaction history” refers to recorded data representing previous exchanges between the user and the system, including at least previous audio inputs, character data, prompt sentences, and response sentences.

The term “past biological information history” refers to time-ordered records of biological information collected for the subject person over a period of time.

The term “past behavioral history” refers to time-ordered records of behavioral history information collected for the subject person over a period of time.

The term “past warning history” refers to records of previously detected abnormal states and associated warning information generated for the subject person.

The term “professional organization system” refers to an external information processing system operated by a medical or care-related organization, such as a clinic, hospital, or care management entity, that can receive biological information and related context information and can provide instruction information.

The term “instruction information” refers to information received from a professional organization system that indicates guidance, orders, or recommendations regarding care, monitoring, or response actions for the subject person.

The term “communication control” refers to operations performed by the processor to establish, manage, and terminate data exchanges between the system and external devices or systems, including the generative artificial intelligence model and professional organization systems.

The term “audio information” refers to data representing sound, including synthesized speech corresponding to response information, alert sounds representing warning information, and any other audio output intended for the user.

The term “graphic information” refers to non-textual visual data, including images, icons, diagrams, and other graphical elements used to supplement or represent response information and warning information.

The term “superimposed visual presentation” refers to a mode of display in which character information and graphic information are overlaid on a view of the real world or on other visual content within the display unit.

In one embodiment, a server, a terminal, and a user cooperate to implement a system that generates and uses structured prompt sentences for a generative AI model in conjunction with multimodal sensing, augmented reality presentation, and communication with external professional organization systems.

The terminal comprises a wearable device, such as smart glasses, that incorporates a transparent display unit, an audio input/output unit, an eye-tracking component, a wireless communication module, and one or more processing circuits executing an embedded operating system. The display unit includes, for example, a transparent organic light emitting panel and an optical combiner that superimposes character information and graphic information on the user's real-world field of view. The audio input/output unit includes at least one microphone and at least one sound reproduction device, such as a bone-conduction transducer, and is driven by an audio codec controlled by the terminal processor. The eye-tracking component includes at least one infrared illumination source and at least one image sensor, and the terminal processor executes an eye-tracking library (for example, based on an eye-tracking software development kit or an OpenCV-based algorithm) to estimate the gaze direction of the user.

The server comprises a processor, a memory, and one or more communication interfaces. The server processor executes a software stack that may include a web application framework, an application server, a database management system, a speech recognition engine, a natural language processing engine, and a generative AI client module for accessing a generative AI model. The memory stores executable instructions and data structures, including user profiles, subject person profiles, biological information histories, behavioral histories, medical-related information, template information for prompt sentences, and log records of generated prompts and responses.

The server receives audio signals captured by the terminal. The terminal digitizes the audio using an analog-to-digital converter and applies an audio preprocessing module, such as a noise suppression and echo cancellation algorithm implemented with an audio processing library. The terminal encodes the audio using a compression codec, such as an adaptive transform-based codec, and transmits the audio data to the server over a secure transport protocol via the wireless communication module and a network.

The server performs automatic speech recognition on the received audio. In one embodiment, the server uses a deep neural network-based speech recognition engine that includes an acoustic model implemented as a recurrent neural network or a transformer encoder, and a language model implemented as an n-gram model or a transformer decoder. The acoustic model receives feature vectors, such as Mel-frequency cepstral coefficients or filter bank energies, and outputs a sequence of phonetic or subword probabilities. A decoding algorithm, such as a beam search decoder, combines acoustic scores and language model scores to generate a character sequence that represents character data corresponding to the user's utterance.

The server executes a natural language processing module on the character data. The server tokenizes the character data using a tokenizer configured for a transformer-based model and converts the tokens to integer indices. The server feeds the indices into a neural network-based model, such as a bidirectional encoder representation model. The model outputs contextual embeddings and classification logits. The server applies a softmax function to the logits and selects an intent label corresponding to the highest probability, thereby determining a user intention such as a medication inquiry, an emergency procedure request, or a request for an explanation of a displayed object. The server also performs entity extraction by applying a sequence labeling model, such as a conditional random field or a transformer with token classification heads, to identify entities including medication names, times, symptoms, and object identifiers.

The server uses the user intention and the extracted entities to retrieve context information from one or more data stores. The server accesses a subject person profile table that stores attribute information such as age, sex, diagnosed conditions, and risk classifications. The server retrieves biological information from a time-series database that maintains sequences of measurements including heart rate, blood pressure, and body temperature, indexed by timestamps and sensor identifiers. The server queries a behavioral history store that records exercise sessions, sleep intervals, and task completion events. The server accesses medical-related information stored in structured records describing medication schedules, dosages, contraindications, and previous instructions from professional organizations.

The server constructs a structured internal representation of context information. In one embodiment, the server builds a data object that includes fields for user intention, subject person identifier, current time, vital sign summaries, medication schedule entries, recent alerts, and gaze target identifiers supplied by the terminal. The server calculates derived features, such as moving averages and recent trend slopes of vital signs, by applying sliding window operations to the time-series data. The server normalizes time expressions to a canonical format and resolves references to relative times, such as “next close,” into absolute schedule entries.

The server generates a prompt sentence for a generative AI model based on the structured context. The server maintains template information in memory, where each template corresponds to a combination of user intention and domain, such as a medication query template, an emergency procedure template, or an object explanation template. Each template includes predefined segments, such as a role description, constraints, and output formatting guidelines. The server selects the appropriate template and fills placeholder fields with context information, including subject person attributes, summarized biological information, and identifiers of display elements or physical objects that correspond to the user's gaze.

For example, when the user requests medication timing information, the server may generate a prompt sentence such as:
“You are an assistive AI for caregivers. Use only the provided data. If information is missing, state that it is not available and advise contacting a professional.

The caregiver is asking for the next medication time.

Current time: 13:25.

Care receiver: 78-year-old person with hypertension and type 2 diabetes.

Medication schedule today (24-hour format):
Antihypertensive drug 5 mg at 08:00 and 20:00
Antidiabetic drug 500 mg at 08:00, 12:00, and 18:00

Please answer in English:
1. What is the next medication time?
2. Which drug should be given?
3. Provide one short caution if relevant.”

When the user requests emergency instructions in response to a fall, the server may generate a prompt sentence such as:

“The caregiver reports that the care receiver has fallen.

Patient: 82-year-old person with a history of bone fragility and taking anticoagulant medication.

Describe step-by-step emergency procedures suitable for a non-medical caregiver.

Use short steps. Clearly state when to stop moving the patient and when to call emergency services.

Limit the answer to 10 sentences.”

The server transmits the generated prompt sentence to a generative AI model. In one embodiment, the generative AI model is a transformer-based neural network, such as a decoder-only language model, trained on a large corpus of text data. The model has multiple layers of self-attention and feed-forward sublayers, with learned parameters that encode statistical relationships between tokens. The server passes the prompt sentence as a sequence of tokens to the model and receives a sequence of output tokens representing a response sentence. The server post-processes the response sentence. The server converts token indices back into character data and normalizes whitespace and punctuation. The server parses the response into semantic segments, such as main answer, explanatory notes, and cautions, using heuristic segmentation rules or a secondary classifier. The server optionally validates response content against stored medical-related information, for example by verifying that suggested medication names and times match entries in the medication schedule, and by removing or flagging instructions that conflict with constraint data. The server constructs response information that includes text suitable for display, structured fields for integration with user interface elements, and text to be converted into audio.

The server also performs continuous monitoring of biological information. The server receives periodic measurements from sensing devices, such as wearable sensors or room monitoring devices, through network interfaces. The server applies rule-based and statistical algorithms to detect abnormal states. For example, the server compares current measurements to predetermined threshold ranges, calculates temporal gradients to detect rapid changes, and applies a moving variance analysis to identify unstable conditions. The server may also use a machine learning classifier, such as a gradient boosting model, trained on feature vectors that include recent measurement sequences, time of day, and subject person attributes, to classify risk levels. When the server detects an abnormal state, the server generates warning information indicating the type and severity of the abnormal state and an associated code.

The terminal receives response information and warning information from the server. The terminal processor controls the display unit to superimpose character information and graphic information in a layout that positions vital sign indicators, alerts, and generative AI responses within the user's field of view. In one embodiment, the terminal uses a rendering engine, such as a graphics library, to draw panels showing current vital signs, icons indicating abnormal states, and text boxes containing instructions or explanations. The terminal adjusts visual properties, such as color, brightness, and size, according to urgency and user preferences.

The terminal receives gaze information from the eye-tracking component. The terminal executes a gaze estimation algorithm that locates pupil centers and corneal reflections in captured eye images, fits a gaze vector model, and maps the gaze vector to coordinates on the display plane or to regions in a three-dimensional scene model. The terminal determines which display element or physical object corresponds to the gaze target. The terminal sends gaze target identifiers and timestamps to the server as part of context information, and locally adjusts the display to emphasize the gazed element, for example by enlarging its bounding region or increasing its contrast.

In one embodiment, when the user gazes at a particular medication label rendered as an augmented reality overlay, the terminal determines that the gaze duration exceeds a threshold time. The terminal transmits an indication of the medication identifier to the server. The server responds by generating a prompt sentence that requests an explanation of the medication, such as:

“The caregiver is looking at the label of a medication with identifier X.

Explain in 3 short bullet points what this medication is commonly used for, the usual precautions, and what the caregiver should check before giving it.

Use plain language suitable for a non-expert caregiver.”

The server sends the prompt sentence to the generative AI model, receives an explanatory response, and returns structured explanation information to the terminal. The terminal overlays the explanation near the medication label and optionally outputs a concise audio summary.

The server communicates with external professional organization systems. The server transmits selected biological information, context information, and warning information to external systems using secure medical data exchange protocols. The server receives instruction information, such as updated care directives or procedural notes, and integrates the instruction information into subsequent prompt sentences and into response information. This configuration allows the system to incorporate authoritative guidance while maintaining a consistent data model and logging all interactions for traceability.

In order to improve computer technology, the system implements specific data structures and algorithms that optimize processing. The server maintains indexed time-series tables for biological information, which enable efficient retrieval of sliding windows of data for anomaly detection and for constructing context features for prompt generation. By computing derived features, such as moving averages and slopes, in a streaming manner, the server reduces redundant computation and memory overhead. The use of template-based prompt generation, instead of free-form concatenation of text, standardizes the structure of prompt sentences and improves reproducibility, auditability, and latency of the generative AI pipeline.

The integration of gaze-derived identifiers into prompt sentences provides a technical effect beyond simple UI enhancement. By embedding precise identifiers of display elements or physical objects into the structured prompt, the system reduces ambiguity and token count in the generative AI input, which in turn reduces processing time and improves accuracy of generated responses. Because the server does not infer intent solely from natural language, but also from computationally determined gaze targets and real-time sensor readings, the server can resolve references such as “this one” or “that medicine” more reliably. This multi-modal, machine-interpretable encoding of context is not a mere automation of human reasoning, but a specific arrangement of hardware and software that enhances the way the computer system handles and routes data.

The generative AI model used by the server is trained using supervised or instruction-tuning techniques. During training, text pairs consisting of prompt sentences and desired responses are provided to the model. A loss function, such as cross-entropy loss over next-token predictions, is computed, and model parameters are updated using gradient descent and an optimizer, such as an adaptive moment estimation algorithm. Data augmentation may be applied by paraphrasing prompts, varying numerical parameters within clinically acceptable ranges, and including synthetic examples that stress boundary conditions. The server may further fine-tune the generative AI model on domain-specific corpora that include caregiving instructions and medical explanations, thereby improving response quality in the target environment.

The server's modular architecture separates speech recognition, natural language understanding, context retrieval, prompt generation, generative AI interaction, response post-processing, and anomaly detection into distinct components, each with well-defined interfaces. This modularity allows the server to schedule tasks efficiently, allocate computing resources dynamically, and cache intermediate results. For example, the server may reuse context representations for multiple related prompt sentences in a session, reducing database access frequency and latency. The system thereby improves overall processing speed and reduces communication load between the terminal and the server.

In another embodiment, some of the described functions may be shifted between the server and the terminal. For example, the terminal may perform on-device speech recognition using a compact acoustic model to generate interim character data, while the server performs deeper natural language processing and context integration. In a different configuration, the terminal may execute a reduced-size generative AI model for low-latency responses when network connectivity is limited, and the server may later reconcile and log the interaction when connectivity is restored. These alternative arrangements demonstrate that the claimed concepts are not limited to a single hardware layout and can be implemented with different processing distributions while preserving the technical advantages of structured prompt generation and multimodal integration.

The user operates the system by wearing the terminal, speaking naturally, and directing gaze toward relevant information or objects. The user does not manually construct any machine-oriented instructions. Instead, the server and terminal cooperate to transform raw sensor streams, gaze data, and dialog history into structured prompt sentences, optimized for a generative AI model, and to convert the generated responses into actionable and context-adapted guidance. This configuration results in improved responsiveness, higher accuracy of context-dependent responses, and reduced cognitive load for the user, achieved through specific improvements in computer-implemented data processing, rather than through mere automation of human decision making.

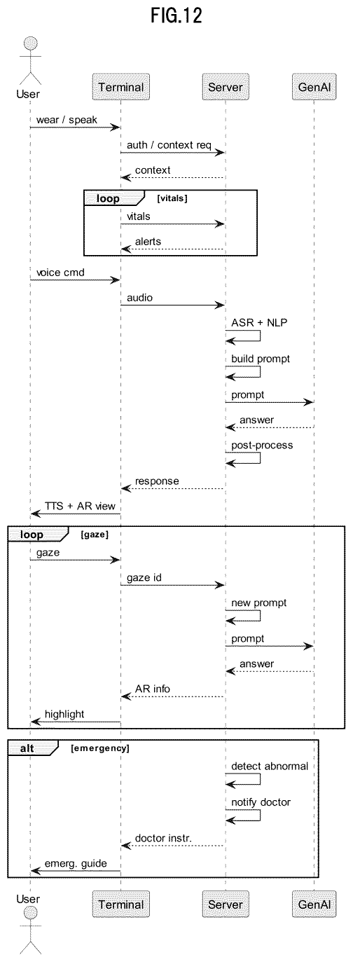

The following describes the processing flow using FIG. 12.

### Step 1:

The terminal initializes hardware and software components.

The terminal loads device drivers for a transparent display unit, an audio input/output unit, an eye-tracking component, and a wireless communication module, and starts an operating system service that manages these components.

The input to this step is a power-on event and configuration data stored in non-volatile memory. The terminal reads the configuration data, allocates memory buffers, initializes communication sockets, and sets initial states of device controllers, thereby producing an initialized runtime environment as output.

### Step 2:

The user wears the terminal and selects a subject person.

The user places the wearable device on the head, and uses voice or a physical control to confirm login.

The input to this step is user identifier information and a list of subject persons received from the server.

The terminal displays the list on the transparent display, accepts a selection command from the user, and outputs a current subject person identifier that will be used in subsequent processing.

### Step 3:

The terminal establishes a secure communication session with the server.

The terminal sends authentication credentials or a device token to the server over an encrypted channel and waits for a response.

The input to this step is the user identifier, device token, and network parameters.

The server verifies the credentials using a user database, generates an access token, and returns the access token to the terminal.

The output of this step is an established session state that includes the access token and associated permissions.

### Step 4:

The server sends initial context information for the selected subject person.

The server retrieves attribute information, biological information summaries, behavioral history summaries, and medical-related information from databases using the subject person identifier as a key.

The input to this step is the subject person identifier and access token received from the terminal.

The server executes database queries, constructs structured records for profile data, recent vital sign statistics, and medication schedule entries, and transmits these records to the terminal as context information.

The output of this step is a set of context records delivered to the terminal.

### Step 5:

The terminal presents initial context and starts monitoring biological information.

The terminal parses the context records, creates internal data structures that store current vital sign thresholds and schedules, and configures display elements.

The input to this step is the context information provided by the server and any direct sensor connections available to the terminal.

The terminal updates overlay panels on the transparent display to show baseline vital signs and schedules and subscribes to biological information updates from the server or sensors, producing a visual context presentation and an active monitoring state as output.

### Step 6:

The server receives and aggregates continuous biological information.

The server accepts measurement packets from sensing devices or from the terminal, each packet including a timestamp, measurement type, value, and subject person identifier.

The input to this step is a stream of measurement packets.

The server inserts each measurement into a time-series database, computes incremental statistics such as moving averages and slopes using sliding windows, and marks each new sample as normal or abnormal according to rule sets, thereby outputting updated biological information summaries and abnormal state indicators.

### Step 7:

The server pushes updated biological information and alerts to the terminal.

The server packages the latest summaries and abnormal indicators for the subject person and sends them to the terminal via a push mechanism or polling response.

The input to this step is the updated biological information summaries and abnormal state flags computed in the previous step.

The server formats the data as structured messages and transmits them to the terminal, producing real-time update messages as output.

### Step 8:

The terminal updates the display and local alert state based on received biological information.

The terminal receives the update messages, decodes the content, and maps each vital sign to its corresponding display element.

The input to this step is the structured messages sent by the server.

The terminal compares the incoming values with locally stored thresholds, recalculates short-term trends, updates numerical displays and colors, and triggers a local audiovisual alert if any value crosses a threshold or changes rapidly, thereby outputting a refreshed augmented reality view and an alert signal for the user.

### Step 9:

The user issues a voice command to request information or instructions.

The user speaks toward the audio input/output unit, for example saying a phrase such as “When is the next medicine?” or “What should I do after this fall?”

The input to this step is the user's spoken utterance.

The terminal captures the analog audio signal, converts it to digital form, and stores it in an audio buffer, producing digitized audio data as output.

### Step 10:

The terminal preprocesses and transmits the audio data.

The terminal applies noise suppression and echo cancellation algorithms to the audio buffer, segments the audio into frames, and encodes the frames using a compression codec.

The input to this step is the raw digitized audio data.

The terminal calculates spectral features to estimate background noise, subtracts noise components, compresses the cleaned signal, and attaches metadata such as user identifier and subject person identifier, then transmits the processed audio packet to the server, generating a network message as output.

### Step 11:

The server performs automatic speech recognition.

The server receives the network message, extracts the compressed audio, decodes it, and computes acoustic features such as Mel-frequency coefficients.

The input to this step is the cleaned and compressed audio data with metadata.

The server feeds the acoustic features into an acoustic model implemented as a neural network, applies a decoding algorithm that combines acoustic probabilities and language model scores, and produces character data representing the recognized text as output.

### Step 12:

The server executes natural language processing to determine user intention and entities.

The server tokenizes the character data, converts tokens to indices, and passes them through an intent classification model and an entity extraction model.

The input to this step is the recognized character data from the speech recognizer.

The server calculates contextual embeddings, computes intent probabilities, selects an intent label, and assigns entity tags to token spans, thereby outputting a user intention value and a set of extracted entities such as medication names, times, and symptoms.

### Step 13:

The server retrieves detailed context information based on intention and entities.

The server uses the subject person identifier, user intention, and entities to construct queries for databases storing attribute information, biological information histories, behavioral histories, and medical-related information.

The input to this step is the user intention, extracted entities, and identifiers from metadata.

The server executes indexed queries, aggregates relevant records, computes derived statistics such as recent vital sign trends, and normalizes time and quantity formats, generating a structured context object as output.

### Step 14:

The server selects a template and generates a prompt sentence for a generative AI model.

The server inspects the user intention and chooses a template corresponding to a medication query, emergency procedure request, explanation request, or other category.

The input to this step is the structured context object and a set of stored templates.

The server fills placeholders in the template with specific values from the context object, concatenates static instruction segments and dynamic context segments, and forms a prompt sentence in natural language, producing a completed prompt sentence as output.

### Step 15:

The server optionally incorporates gaze information into the prompt sentence.

The server receives gaze target identifiers from the terminal, indicating which display element or physical object the user is looking at.

The input to this step is the completed prompt sentence and any gaze target identifier related to the current interaction.

The server modifies the prompt sentence by appending or inserting a description of the gaze target, such as an object label or medication identifier, and clarifies pronoun references, thereby outputting a refined prompt sentence that encodes gaze-derived context.

### Step 16:

The server invokes the generative AI model using the prompt sentence.

The server submits the prompt sentence as tokenized input to a generative AI model interface, specifying model configuration parameters such as maximum output length and temperature.

The input to this step is the refined prompt sentence.

The generative AI model processes the token sequence and predicts a sequence of output tokens; the server converts the tokens into text, generating a response sentence as output.

### Step 17:

The server validates and structures the response sentence.

The server parses the response sentence, identifies key segments such as main answer, warnings, and step-by-step instructions, and cross-checks references against stored medical-related information.

The input to this step is the raw response sentence from the generative AI model and the context object.

The server removes or flags any inconsistent content, restructures the text into labeled fields, and creates response information that includes text for display, text for audio output, and structured key values, generating a response packet as output.

### Step 18:

The server transmits the response packet to the terminal.

The server encapsulates the response information in a network message, attaches session identifiers, and sends the message over the established secure channel.

The input to this step is the structured response packet generated in the previous step.

The server writes a log entry for traceability and delivers the message to the terminal, producing a delivered response message as output.

### Step 19:

The terminal generates audio output from the response packet.

The terminal extracts the text designated for speech, passes it to a text-to-speech engine, and generates an audio waveform.

The input to this step is the delivered response message received from the server.

The terminal applies prosody and voice parameters, synthesizes speech samples, and drives the audio codec and sound reproduction device, outputting spoken guidance to the user.

### Step 20:

The terminal updates the display with the response information.

The terminal parses textual and structured fields from the response packet and maps them to specific display elements such as panels, icons, and lists.

The input to this step is the same response message used for audio output.

The terminal renders new or updated elements on the transparent display, adjusts positions to avoid occluding critical real-world regions, and applies emphasis styles based on urgency, generating an updated visual overlay as output.

### Step 21:

The terminal tracks gaze and emphasizes focused information.

The terminal acquires eye images from the eye-tracking component, computes gaze vectors, and determines which display element is being gazed at.

The input to this step is a stream of eye image data and the current layout of display elements.

The terminal calculates gaze coordinates, compares them to element bounding boxes, selects the active gaze target, and modifies rendering attributes such as size and brightness of the selected element, thus outputting an emphasized visual representation and, optionally, a gaze target report sent to the server.

### Step 22:

The server detects abnormal states and generates warning information.

The server continuously analyzes new biological information records using threshold rules and statistical models.

The input to this step is the stream of biological information measurements stored in the time-series database.

The server computes differences, averages, and risk scores, determines whether any indicator exceeds its allowed range or changes too quickly, and constructs warning information that includes type, severity, and recommended urgency level, producing a warning message as output.

### Step 23:

The server integrates warning information into prompt sentences and response information when appropriate.

The server determines whether the current interaction or context requires inclusion of warnings, for example when the user asks about activity or medication during an abnormal state.

The input to this step is the warning message and the structured context object.

The server appends warning descriptions and safety constraints to the prompt sentence or directly to the response information, then updates or generates new response packets, producing context-aware warning outputs as a result.

### Step 24:

The server communicates with an external professional organization system when predefined conditions are met.

The server monitors warning information and instruction rules that indicate when escalation is required.

The input to this step is the warning message and escalation policy data.

The server formats a summary of relevant biological information, context, and detected abnormalities, sends the summary to the external system, and receives instruction information, thereby outputting updated guidance that can be merged into subsequent responses.

### Step 25:

The terminal presents instruction information from the external professional organization system.

The terminal receives updated guidance within a response packet, extracts the instruction content, and displays it prominently while also converting it to speech.

The input to this step is the response packet containing instruction information.

The terminal positions the instruction text at a central region of the display, highlights it, and plays a corresponding audio message, outputting clear, externally authorized directions to the user.

### Step 26:

The user follows the guidance and optionally confirms task completion.

The user observes or listens to the instructions, performs corresponding actions in the real environment, and provides a confirmation input, such as saying “Medication given” or “Procedure completed.”

The input to this step is the guidance delivered by the terminal and the user's actual actions.

The terminal captures the confirmation as a new voice command or gesture, and sends a completion event to the server, generating a log update and closing the current interaction cycle.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

The specific processing by the specific processing unit 290 of the data processing device 12 in Example 2 is realized by the following means.

The term “system” refers to an information processing arrangement including at least one processor and one or more functional units such as a display unit, an audio input/output unit, a gaze detection unit, a communication unit, and memory, which cooperate to perform the claimed processing.

The term “processor” refers to a hardware computing element, such as a central processing unit, a graphics processing unit, or a system-on-chip, or a combination thereof, which executes instructions stored in a memory to implement the claimed functions.

The term “display unit” refers to an output apparatus that presents visual information to a user and includes at least one display section configured to overlay character information and image information within a field of view of the user.

The term “head-mounted display” refers to a wearable apparatus that is mounted on the head of a user and includes at least one transmissive or semi-transmissive display section positioned in front of the user's eyes to present visual information superimposed on a real-world scene.

The term “transmissive or semi-transmissive display section” refers to a display panel structure that permits at least part of light from an external environment to pass through while also presenting computer-generated visual content so that the content appears overlaid on the external environment.

The term “character information” refers to visual information composed of symbols, letters, numerals, or text strings that can be recognized as linguistic units by the user.

The term “image information” refers to visual information composed of two-dimensional or three-dimensional graphical elements, pictures, icons, or diagrams other than solely textual characters.

The term “audio input/output unit” refers to a functional unit including at least one audio input section and at least one audio output section that collectively acquire sound from the user and provide sound to the user.

The term “audio input section” refers to a component, such as a microphone and associated circuitry, that converts acoustic signals, including speech of the user, into electrical or digital signals for processing.

The term “audio output section” refers to a component, such as a speaker or a bone-conduction transducer and associated circuitry, that converts electrical or digital audio signals into sound perceivable by the user.

The term “gaze detection unit” refers to a functional unit including at least one imaging element and an image processing mechanism that captures images of an eyeball and a head posture of the user and determines a gaze direction and a fixation position of the user based on the images.

The term “gaze direction” refers to a directional vector indicating an orientation of a visual line of the user derived from at least one of an eyeball orientation and a head posture.

The term “fixation position” refers to a position within a coordinate space, such as a display coordinate system or a scene coordinate system, at which the gaze direction of the user remains substantially stable for at least a predetermined duration.

The term “fixation time” refers to a time interval during which the gaze direction of the user remains within a predetermined spatial region corresponding to a fixation position.

The term “gaze movement pattern” refers to a temporal pattern of changes in the gaze direction or gaze position of the user, including at least one of saccade speed, saccade direction, and transition frequency between fixation positions.

The term “network” refers to a communication infrastructure, including at least one wired or wireless communication link and associated protocols, that enables data exchange between the system and a remote computing resource.

The term “remote computing resource” refers to an external information processing apparatus, such as a server or a cloud computing platform, that is connected to the system via the network and provides computation or storage for at least part of the claimed processing.

The term “audio data” refers to digital information representing sound, including sampled speech signals of the user, in a format suitable for processing by a speech recognition algorithm.

The term “speech recognition process” refers to a computational procedure that receives audio data as input and outputs text data representing recognized linguistic content of the audio data.

The term “acoustic feature extraction processing” refers to a process that transforms audio data into a sequence of feature vectors, such as spectral coefficients, cepstral coefficients, or filter bank energies, suitable for subsequent statistical or neural modeling.

The term “language model processing” refers to a process that uses a probabilistic or neural model of language to determine or refine a sequence of linguistic units, such as words or sub-word tokens, based on acoustic features and linguistic constraints.

The term “text data” refers to digital information representing linguistic content as a sequence of characters, words, or tokens produced by the speech recognition process or by a text generation process.

The term “emotional state” refers to a psychological or affective condition of the user, including at least one of joy, anger, fear, fatigue, confusion, interest, curiosity, indecision, or anxiety, expressed as a categorical label or as a continuous value.

The term “emotion label” refers to a symbolic representation of an emotional state, such as a discrete category indicating a predominant affective condition of the user.

The term “continuous value” refers to a numerical scalar or vector quantity representing at least one dimension of an emotional state, such as arousal, valence, or engagement, that can vary over a continuous range.

The term “acoustic feature” refers to a measurable attribute of audio data, including at least one of pitch, volume, speaking rate, spectral shape, or other descriptors obtained from the audio signal.

The term “gaze information” refers to data derived from gaze detection processing, including at least one of gaze direction, fixation position, fixation time, gaze movement pattern, and gaze staying position.

The term “history information” refers to stored data associated with a user, including at least one of past utterances, past information requests, previously viewed content, location history, or inferred preferences, used for personalization.

The term “position information” refers to data indicating a geographic or spatial location of the user, such as coordinates, region identifiers, or point-of-interest identifiers, at a given time.

The term “generative artificial intelligence model” refers to a machine-learned model, such as a neural network based on a transformer architecture, that generates natural language text or other content in response to input conditions.

The term “prompt sentence” refers to an input text supplied to the generative artificial intelligence model, including at least one of a user request, contextual information, instructions on explanation style, or constraints on output format, for guiding generation of a response.

The term “tokenize” refers to a process of converting text into a sequence of units, such as words, subwords, or symbols, that are used as input to the generative artificial intelligence model.

The term “autoregressive decoding” refers to a generation process in which a next token is predicted sequentially based on previously generated tokens and the prompt sentence until a termination condition is satisfied.

The term “answer text” refers to text generated by the generative artificial intelligence model in response to the prompt sentence, including at least one of summary information, detailed information, and supplementary information.

The term “information presentation format” refers to a set of parameters defining how information is provided to the user, including at least one of display position, display size, visibility state, emphasis, speaking rate, and voice quality.

The term “summary information” refers to a portion of the answer text that expresses a condensed representation of content in a shorter or simpler form suitable for rapid comprehension.

The term “detailed information” refers to a portion of the answer text that expresses expanded or more specific content, including additional explanations, examples, or technical details.

The term “folded or expanded state” refers to a display condition of a visual element in which content is either hidden or reduced (folded) or fully shown (expanded) in a user interface.

The term “speaking rate” refers to a temporal characteristic of synthesized speech, such as the number of syllables or words per unit time, controlled by the system.

The term “voice quality” refers to an audible characteristic of synthesized speech, including at least one of pitch, timbre, tone, and prosody, that affects how the speech is perceived by the user.

The term “first emotion estimation unit” refers to a functional unit that estimates an emotional state of the user based on acoustic features extracted from audio data.

The term “second emotion estimation unit” refers to a functional unit that estimates an emotional state of the user by performing emotion analysis on text data using a natural language processing model.

The term “third emotion estimation unit” refers to a functional unit that estimates at least one of a degree of interest, a degree of hesitation, and a degree of concentration of the user based on gaze information.

The term “integrated emotion estimation unit” refers to a functional unit that combines outputs of the first emotion estimation unit, the second emotion estimation unit, and the third emotion estimation unit to determine a comprehensive emotional state of the user.

The term “fatigue state” refers to an emotional state in which the user exhibits reduced concentration or increased tiredness inferred from at least one of acoustic features, text expressions, and gaze patterns.

The term “confusion state” refers to an emotional state in which the user exhibits difficulty in understanding or processing information inferred from at least one of repeated questions, linguistic cues, and unstable gaze behavior.

The term “interest” refers to a level of positive engagement of the user with presented information inferred from at least one of sustained gaze, follow-up questions, and vocal characteristics.

The term “curiosity” refers to a heightened form of interest in which the user seeks additional information or deeper explanations beyond a basic answer.

The term “related information” refers to additional content associated with a main topic of the answer text, such as background information, comparisons, or recommendations, that is not strictly necessary for minimal understanding.

The term “supplementary information” refers to a subset of related information presented as optional or secondary content that can be selectively displayed according to the user's behavior or emotional state.

The term “gaze staying position” refers to a spatial region in which the gaze of the user remains for at least a predetermined threshold duration, indicating attention to that region.

The term “predetermined threshold” refers to a value defined in advance, such as a time interval or magnitude, used as a criterion for triggering a state change, including expansion of detailed information.

In one exemplary embodiment, a system includes a terminal worn by a user and a server connected to the terminal via a communication network. The terminal and the server each include at least one processor, memory, and communication circuitry, and cooperate to implement the functions recited in the claims.

The terminal is configured as a head-mounted display device. The terminal includes a transmissive or semi-transmissive display unit arranged in front of the user's eyes, an audio input/output unit, a gaze detection unit, inertial sensors, a wireless communication module, and a local processor. The local processor executes an embedded operating system such as a mobile operating system, an augmented-reality rendering engine such as a game-engine-type middleware, an audio capture and playback stack, and a gaze-tracking application. The display unit superimposes character information and image information on the user's real-world field of view. The audio input/output unit includes at least one microphone and at least one sound transducer such as a bone-conduction speaker. The gaze detection unit includes an inward-facing camera and image-processing logic.

The server is implemented as a remote computing resource and includes a multi-core processor, a graphics processing unit, main memory, and a mass storage device. The server executes an operating system, a web application framework, a WebSocket server, a speech recognition engine, an emotion estimation engine, a generative AI model execution engine, and a response generation and layout control engine. The server stores user history data, content databases, trained neural network parameters, and configuration parameters in a database system.

The terminal acquires audio signals from the user by the microphone of the audio input/output unit and converts the analog signals into digital audio data by an A/D converter and an audio driver. The terminal uses a noise suppression library, such as a frequency-domain spectral subtraction module, to reduce background noise. The terminal then encodes the audio data with a general audio codec such as an adaptive transform-based codec to obtain compressed audio data. By executing these preprocessing operations on the terminal, the system reduces the amount of data transmitted to the server and decreases latency and network load. The use of noise suppression on the terminal improves the signal-to-noise ratio of the audio data supplied to the server, thereby improving recognition accuracy of the downstream speech recognition engine. The terminal acquires images of the user's eyes and face by the gaze detection unit and processes these images using an image processing library such as a general image processing framework and a facial landmark detection library. The terminal detects positions of eye-related landmarks, determines an eyeball orientation, and combines the orientation with head pose information from inertial sensors to compute a gaze direction. The terminal projects the gaze direction into a display coordinate system to obtain gaze coordinates and calculates fixation times and gaze movement patterns. The terminal transmits the compressed audio data, gaze information, and position information to the server via the wireless communication module and a WebSocket client.

The server receives the multimodal data from the terminal and decodes the compressed audio data into a digital waveform. The server performs speech recognition by computing acoustic features such as log-Mel filter bank coefficients or Mel-frequency cepstral coefficients using an audio feature extraction library. The server inputs a sequence of acoustic feature vectors into a neural acoustic model. In one embodiment, the acoustic model is a transformer-based or conformer-based neural network trained with a combination of cross-entropy loss and connectionist temporal classification loss. The server uses a language model, which may be a recurrent neural network or a transformer language model, to decode a most probable token sequence by beam search. The server thereby generates text data corresponding to the user's utterance.

The server estimates an emotional state of the user based on multiple modalities. The server extracts acoustic features such as pitch, energy, speaking rate, and spectral shape from the digital waveform. The server inputs these features into a first emotion estimation unit implemented as a neural network, such as a convolutional and recurrent network trained to output probabilities of emotion classes. The server inputs the recognized text data into a second emotion estimation unit implemented as a transformer-based text classifier trained to predict sentiment polarity, confusion markers, or urgency indicators by minimizing a cross-entropy loss on labeled text data. The server processes the gaze information by calculating statistics such as average fixation duration, distribution of gaze over regions of interest, and saccade speed. The server inputs these statistics into a third emotion estimation unit, for example a long short-term memory network trained to produce continuous values representing at least interest, hesitation, and concentration. The server integrates outputs from the first, second, and third emotion estimation units using an integrated emotion estimation unit. In one embodiment, the integrated emotion estimation unit is a meta-classifier implemented as a small feed-forward neural network or an ensemble model. The integrated emotion estimation unit receives as input a feature vector including, for example, probabilities of acoustic emotion classes, probabilities of text emotion classes, and continuous values of gaze-based indicators. The integrated emotion estimation unit outputs an emotion label or continuous scores representing a comprehensive emotional state such as “fatigue and low concentration,” “indecision and anxiety,” or “high interest.” By combining these heterogeneous signals, the server improves robustness and precision of emotion estimation compared with conventional single-modality methods, which leads to more appropriate control of information presentation and reduces misclassification errors.

The server further obtains history information and position information associated with the user from a data store. The history information includes past utterances, past responses, consumed content items, and inferred preferences. The position information includes geographic coordinates or identifiers of physical places or objects near the user. The server then generates a prompt sentence to be supplied to a generative AI model. The server uses a template engine to create the prompt sentence by inserting explicit fields representing the recognized text, history information, position information, and the estimated emotional state into a prompt template. The server does not merely passively forward the user's question to the generative AI model. Instead, the server explicitly encodes system-level control directives into the prompt sentence that guide the generative AI model to generate outputs that match the current cognitive load and emotional state of the user. For example, when the estimated emotional state indicates fatigue, the server constrains the generative AI model to output a shorter summary with simple wording and to append an explicit question asking whether the user wants more details. When the estimated emotional state indicates high curiosity, the server instructs the generative AI model to output a long, structured explanation with headings and examples. This explicit use of emotion-conditioned control information in the prompt sentence improves consistency of generated responses and avoids unnecessary trial-and-error requests from the user, thereby reducing network traffic and computation time for subsequent turns.

In a first concrete example, when the user asks for historical information in a tourist context and the estimated emotional state indicates fatigue and low concentration, the server generates the following prompt sentence:

“You are a tourist guide AI.

The user is sightseeing and wants to know the history of this building.

The user is somewhat tired and does not prefer long or complex explanations.

First, explain the key historical points in about three concise sentences.

Then add the sentence ‘Would you like to know more details?’.

Avoid technical terms and explain in simple Japanese that an elementary school student can understand.

Assume the building is a representative historical structure near the user's current location.”

In a second concrete example, when the user is shopping and the estimated emotional state indicates indecision and anxiety, the server generates the following prompt sentence:

“You are a shopping advisor AI.

The user is hesitating between smartphone A and smartphone B near their current location.

The user feels anxious and wants a clear and simple recommendation.

First, compare A and B in a concise table with price, battery life, camera performance, and weight.

Then choose only one device and explain in about 400-500 Japanese characters why it is more suitable for typical daily use (web browsing, photos, videos).

Use simple language and a reassuring tone that reduces the user's anxiety.

Avoid overly technical jargon, and briefly explain any necessary technical term.”

The server tokenizes the prompt sentence using a tokenizer associated with the generative AI model, such as a subword tokenizer trained with byte-pair encoding or a similar algorithm. The server then inputs the token sequence to the generative AI model implemented as a transformer-type neural network. The generative AI model includes multiple self-attention layers, feed-forward layers, and layer normalization layers. The generative AI model has been trained on a large corpus of text using a next-token prediction objective with a cross-entropy loss and gradient-based optimization such as stochastic gradient descent with adaptive learning rate. During training, the server or an offline training system uses mini-batches of token sequences, applies data augmentation such as masking or random cropping of sequences, computes gradients of the loss with respect to model weights, and updates the weights using optimization algorithms to converge to a parameter set that generalizes to novel inputs.

The server performs autoregressive decoding to obtain an answer text. The server selects a decoding algorithm such as beam search or top-k/top-p sampling with a temperature parameter to balance diversity and determinism. The server may impose explicit length constraints or section markers specified in the prompt sentence. This decoding process produces answer text that reflects the emotional directives encoded in the prompt sentence, such as brevity, level of detail, and tone.

The server analyzes the generated answer text and separates portions of the text into a summary portion and a detailed portion based on markers, headings, or predetermined text patterns. The server constructs a data structure that associates each portion with metadata indicating its priority, recommended layout, and reading order. The server then determines an information presentation format based on the comprehensive emotional state. When the emotional state indicates fatigue or confusion, the server marks the summary portion as a primary section to be displayed in a central region of the display and the detailed portion as secondary content to be displayed in a folded state. When the emotional state indicates high interest or curiosity, the server marks both the summary and detailed portions to be initially expanded and may additionally mark supplemental content for display.

The server generates control parameters for visual presentation, including display positions in a virtual coordinate system, font sizes, colors, and fold/expand states. The server also generates control parameters for audio presentation, including speaking rate and voice quality (pitch and prosody profile). By adjusting these parameters based on the emotion state, the system optimizes readability and cognitive load, which leads to reduced user errors (e.g., missed instructions) and shorter interaction times.

The terminal receives the answer text and control parameters from the server. The terminal uses the AR rendering engine to place text objects in the user's field of view according to the display positions and font sizes. In one example, the terminal renders the summary text as a rectangular overlay near the lower central portion of the field of view with a large font size and high-contrast color. The terminal renders the detailed text as a smaller folded overlay with an icon or label that can be expanded. The terminal also supplies the selected portion of the answer text to a text-to-speech engine running on the terminal. The text-to-speech engine converts the text to an audio waveform in accordance with the speaking rate and voice quality parameters. The terminal outputs the synthesized audio via the bone-conduction speaker, allowing the user to hear the explanation while still perceiving environmental sounds through air conduction.

The terminal continuously monitors the user's gaze through the gaze detection unit and updates a gaze state. When the terminal detects that the user's gaze remains on the region where the detailed text is folded for a time longer than a threshold, the terminal expands the folded detailed text and may notify the server of this event. Conversely, when the user's gaze moves away from the detailed region and remains away for a certain duration, the terminal may fold the detailed text again. This behavior uses the gaze signal both as an input to emotion estimation and as a local control signal for just-in-time expansion of information. This configuration improves user experience and also reduces the amount of text that must be rendered and managed at any given time, thereby reducing rendering workload and power consumption.

The described architecture and processing provide improvements to computer technology itself. The multimodal emotion estimation and prompt-controlled generative AI processing reduce unnecessary iterations of question/answer exchanges, which lowers the total number of network requests and server-side model invocations. The combined use of acoustic, textual, and gaze features improves emotion estimation accuracy compared with single-modality systems, which directly improves the relevance and appropriateness of generated responses. As a result, the system reduces the likelihood that the user will request repeated explanations, which decreases computation time and memory consumption on the server. The dynamic control of display layout and audio parameters based on the emotion state optimizes resource usage on the terminal, as the system can avoid rendering and reading out unnecessary detailed content when the user is fatigued or not interested.

The system does not merely automate human decision-making, but implements non-conventional rules and processing sequences tailored to the capabilities of generative AI models and to constraints of AR hardware. For example, the server introduces explicit structural constraints and tone directives into the prompt sentence that are not naturally applied by human operators. These directives cause the generative AI model to organize its internal attention patterns and token generation in a way that ensures sections of the answer text align with technical constraints of the AR rendering pipeline. Moreover, the integrated emotion estimation unit performs algorithmic fusion of heterogeneous features using machine-learned weights that optimize prediction performance in a high-dimensional feature space, which is not a straightforward translation of human heuristics.

In alternative embodiments, the terminal may execute a portion or all of the speech recognition process locally using a compact neural network model and transmit only text data and features to the server. In another embodiment, the terminal may execute a simplified emotion estimation based solely on acoustic features, while the server executes full multimodal emotion estimation. In yet another embodiment, the generative AI model may reside on an external cloud computing platform accessible by the server, and the server may merely construct prompt sentences, perform tokenization, and receive generated token sequences. In each case, the server retains the role of integrating multimodal emotion estimation and adaptive prompt generation for the generative AI model, and the terminal retains the role of implementing display and audio control based on the information presentation format.

Various modifications of the neural network architectures and training procedures are also possible. The first emotion estimation unit may use a convolutional neural network applied to spectrogram images. The second emotion estimation unit may use a bidirectional transformer model fine-tuned on domain-specific conversational data. The third emotion estimation unit may use a gated recurrent unit network with attention over gaze feature sequences. The integrated emotion estimation unit may use a gradient-boosted tree ensemble instead of a neural network. Training may use additional techniques such as regularization, dropout, early stopping, and data augmentation by random noise injection or time-warping of audio and gaze sequences. Such variations still fall within the scope of the claims, as long as the system includes a processor configured to generate a prompt sentence for a generative AI model based on text data, history information, position information, and an estimated emotional state, and to control an information presentation format based on the answer text and the emotional state.

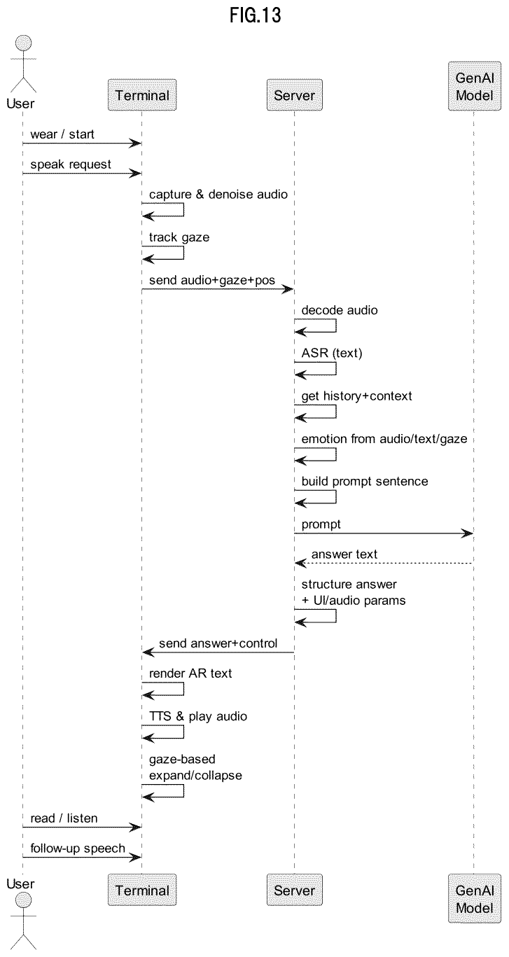

The following describes the processing flow using FIG. 13.

### Step 1:

User wears the terminal and prepares to interact.

User mounts the head-mounted terminal on the head and adjusts the position so that the transmissive display is centered in the field of view.

User visually confirms that the startup screen and a microphone or “ready” icon are shown, indicating that voice input is available.

Input: physical mounting of the terminal by the user.

Output: a stable head-mounted terminal position and a user who recognizes that the system is ready for voice interaction.

### Step 2:

Terminal initializes hardware and establishes a network session.

Terminal powers on, boots an embedded operating system, and starts an AR application and a communication module.

Terminal reads server address and authentication information from local storage, opens a secure network connection, and upgrades it to a persistent WebSocket session with the server.

Input: power-on event and stored configuration data (server endpoint, credentials, language settings).

Output: a live bidirectional communication channel between terminal and server and a running AR application ready to send and receive data.

### Step 3:

User issues a natural language request.

User looks at an object or environment of interest and utters a question or instruction such as

“Tell me the history of this building” or “Which of these two smartphones is better?”

Input: spoken utterance by the user.

Output: acoustic pressure waves in the environment directed toward the terminal microphone.

### Step 4:

Terminal captures and denoises audio.

Terminal uses the microphone and audio driver to convert the acoustic waves into a digital PCM audio stream at a defined sampling rate.

Terminal executes a noise suppression library that applies short-time Fourier transform, estimates background noise spectrum, subtracts or attenuates noise components, and reconstructs a denoised waveform by inverse transform.

Input: analog audio signal at the microphone.

Output: time-aligned digital PCM audio data with reduced background noise.

### Step 5:

Terminal compresses audio and detects speech segments.

Terminal segments the denoised PCM waveform into fixed-length frames and encodes each frame with a speech codec to reduce bitrate.

Terminal performs voice activity detection by computing frame energy and zero-crossing statistics, and groups contiguous voiced frames into an utterance segment.

Input: denoised PCM audio stream.

Output: compressed audio data packets representing a single utterance and metadata marking start and end of the utterance.

### Step 6:

Terminal acquires gaze data and computes gaze features.

Terminal captures eye images from the inward-facing camera and uses an image processing library to detect eye landmarks and pupil center positions.

Terminal reads head pose from inertial sensors and computes a gaze vector by combining eyeball orientation and head orientation, then projects the gaze vector into the display coordinate system to obtain gaze coordinates.

Terminal accumulates gaze coordinates over time, segments them into fixations and saccades, and calculates fixation duration and gaze movement patterns.

Input: eye camera frames and head pose data.

Output: gaze information including sequences of gaze points, fixation times, and gaze movement patterns.

### Step 7:

Terminal collects position and user identifiers and constructs a multimodal message.

Terminal queries a positioning module for current coordinates or a place identifier.

Terminal combines compressed audio data, gaze information, position data, user ID, terminal ID, and timestamps into a structured data object, and serializes it using a messaging format.

Input: compressed audio, gaze information, position information, user ID, terminal ID.

Output: a serialized multimodal message ready for transmission to the server.

### Step 8:

Terminal sends multimodal data to the server.

Terminal uses the established WebSocket session to transmit the serialized multimodal message to the server as a “user request” event.

Input: serialized multimodal message.

Output: a network packet stream containing the multimodal message delivered to the server.

### Step 9:

Server receives and parses the multimodal message.

Server listens on the WebSocket interface, receives the multimodal message, and deserializes it into internal structures.

Server separates compressed audio, gaze information, position information, user ID, terminal ID, and timestamps for further processing.

Input: serialized multimodal message from the terminal.

Output: decoded audio bitstream, gaze data structures, position data, and user identification data.

### Step 10:

Server decodes audio and performs feature extraction.

Server runs the appropriate codec decoder on the audio bitstream to reconstruct PCM audio.

Server computes acoustic features such as log-Mel filter bank energies or cepstral coefficients by windowing the waveform, applying Fourier transform, and aggregating spectral power in predefined frequency bands.

Input: compressed audio bitstream.

Output: PCM audio waveform and a sequence of acoustic feature vectors.

### Step 11:

Server performs automatic speech recognition and obtains text.

Server passes the acoustic feature sequence to a neural acoustic model and a language model, and executes a decoding algorithm such as beam search to determine the most probable token sequence.

Server converts the token sequence into a character or word string in the user's language and applies text normalization rules.

Input: acoustic feature sequence.

Output: recognized text data representing the user's utterance.

### Step 12:

Server constructs a context object from history and location.

Server uses the user ID to query a database for history records such as previous utterances, prior responses, and preference indicators.

Server uses position information to retrieve or infer relevant entities, such as a nearby building or available products, from a content store.

Server combines the recognized text, history data, and entity information into a structured context object describing the current request type and target entity.

Input: recognized text, user ID, position information, history database, content database.

Output: context object including intent type, candidate entities, and user preference indicators.

### Step 13:

Server estimates emotion from acoustic features.

Server inputs the acoustic feature vectors into a first emotion estimation model and computes class probabilities or scores for emotional categories such as joy, anger, fatigue, or neutrality.

Server aggregates temporal predictions across frames to obtain a single acoustic-based emotion summary for the utterance.

Input: sequence of acoustic feature vectors.

Output: acoustic emotion features and class scores indicating probable emotional states.

### Step 14:

Server estimates emotion from text.

Server tokenizes the recognized text and feeds the token sequence into a transformer-based text emotion model.

Server computes output logits and applies a softmax function to derive probabilities for text-based emotion labels such as positive, negative, confused, or urgent.

Input: recognized text.

Output: text-based emotion probabilities and any derived indicators such as confusion flags.

### Step 15:

Server estimates attention and interest from gaze information.

Server parses the gaze information to compute statistics such as average fixation duration, proportion of time spent on specific regions, and frequency of rapid gaze shifts.

Server inputs these statistics into a third emotion estimation model that outputs continuous values for interest, hesitation, concentration, and stress levels.

Input: gaze information including gaze coordinates and fixation data.

Output: gaze-based state indicators representing interest, hesitation, concentration, and stress.

### Step 16:

Server integrates multimodal emotion estimates into a comprehensive emotional state.

Server concatenates acoustic emotion scores, text-based emotion probabilities, and gaze-based indicators into a multimodal feature vector.

Server applies an integrated emotion estimation model, such as a small feed-forward network or ensemble classifier, to this feature vector to determine a comprehensive emotional state label and associated continuous scores.

Input: acoustic emotion features, text-based emotion features, gaze-based indicators.

Output: integrated emotional state of the user, such as “fatigue and low concentration” or “indecision and anxiety.”

### Step 17:

Server generates an emotion-aware prompt sentence for a generative AI model.

Server selects a prompt template based on the intent and context, and fills template fields with the recognized text, entity information, history information, and the integrated emotional state.

Server inserts explicit instructions describing explanation length, complexity, tone, and structure that reflect the emotional state, thereby forming a complete prompt sentence.

Input: context object and integrated emotional state.

Output: a textual prompt sentence tailored to guide the generative AI model.

### Step 18:

Server tokenizes the prompt sentence and invokes the generative AI model.

Server converts the prompt sentence into a sequence of tokens using a tokenizer and feeds the sequence into a transformer-based generative AI model.

Server executes autoregressive decoding, at each step computing next-token probabilities conditioned on the prompt and previously generated tokens, and selects tokens using a decoding strategy such as beam search or top-p sampling.

Input: text prompt sentence.

Output: generated answer text, optionally containing summary, detailed explanation, and supplemental portions.

### Step 19:

Server analyzes and structures the generated answer text.

Server scans the answer text for section markers or uses heuristic rules to split the text into a summary portion, a detailed portion, and optional supplemental portions.

Server constructs a hierarchical data structure that associates each portion with tags indicating type, priority, and default display state.

Input: generated answer text.

Output: structured answer object with labeled text sections.

### Step 20:

Server derives presentation parameters from the emotional state and answer structure.

Server maps the integrated emotional state to layout and audio parameters, such as which sections to emphasize, where to position them on the display, and whether to show them folded or expanded.

Server calculates specific values for font sizes, positions, highlight styles, speaking rate, and voice characteristics, encapsulating them in control parameter objects.

Input: structured answer object and integrated emotional state.

Output: visual layout control parameters and audio playback control parameters.

### Step 21:

Server packages the response and sends it to the terminal.

Server bundles the structured answer object, visual layout control parameters, and audio control parameters into a response message and serializes it.

Server transmits the serialized response message to the terminal using the established WebSocket session.

Input: structured answer and control parameters.

Output: serialized response message delivered to the terminal.

### Step 22:

Terminal receives the response and prepares AR display elements.

Terminal deserializes the response message to retrieve the answer sections and associated control parameters.

Terminal creates AR text objects for the summary and detailed sections and configures their positions, sizes, colors, and initial visibility according to the control parameters.

Input: serialized response message.

Output: configured AR text objects ready for rendering in the user's field of view.

### Step 23:

Terminal renders the summary and detailed information in the user's field of view.

Terminal uses the AR rendering engine to overlay the summary text in a central or prominent region and to display the detailed text as folded or minimized content according to the layout control.

Terminal composites these overlays with the pass-through view of the real environment, ensuring alignment with the user's head orientation.

Input: configured AR text objects and current head pose.

Output: visual display of summary and, if appropriate, detailed information in the user's field of view.

### Step 24:

Terminal converts the selected answer text into speech and plays audio.

Terminal selects the portion of the answer text that should be spoken, typically at least the summary, based on the audio control parameters.

Terminal passes this text to a text-to-speech engine, sets the speaking rate and voice characteristics, and generates an audio waveform that is then output through the audio output unit to the user.

Input: answer text sections and audio control parameters.

Output: synthesized audio delivered to the user in synchrony with the visual display.

### Step 25:

Terminal monitors gaze to support interactive expansion of details.

Terminal continues to track the user's gaze and maps current gaze coordinates to regions of interest corresponding to summary and detailed text areas.

Terminal measures dwell time in each region, and when the gaze remains on a folded detailed region longer than a threshold, the terminal changes the display state to expanded and updates the rendered view.

Input: real-time gaze coordinates and current UI state.

Output: dynamically updated UI state that expands or folds detailed information based on gaze behavior.

### Step 26:

User consumes the information and optionally issues a follow-up request.

User reads the displayed summary and any expanded details and listens to the audio explanation.

User decides whether more information or clarification is needed and, if so, utters a new question or instruction, which serves as a new input to the system and initiates a further processing cycle beginning from the capture of audio at the terminal.

Input: combined visual and auditory information presented to the user.

Output: either completion of the interaction or a new spoken request that restarts the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems that combine speech recognition, natural language processing, and graphical display typically treat user input as a single-modality text stream and generate responses using fixed templates or general-purpose language models. Such systems often execute on generic processors without tailoring core processing pipelines to heterogeneous input signals, such as synchronized audio, image, biometric, and gaze data. As a result, they do not fully exploit available hardware and software resources, and they fail to adapt output content and presentation parameters to the real-time cognitive and emotional state of the user, thereby imposing unnecessary decision-making load on the user and degrading usability in high-stress contexts.

In many implementations, the processor executes separate components for speech recognition, natural language understanding, and response generation, but these components are loosely coupled and do not share a unified representation of user intent, subject state, and emotional state. For example, even when biometric sensors and imaging devices are present, conventional systems either ignore these signals or apply them only to ancillary logging or offline analysis, rather than dynamically controlling the generation and presentation of responses by a generative AI model. This architectural separation leads to increased latency, redundant computations, and an inability to perform fine-grained, real-time adaptation of information volume, layout, and speech characteristics.

Further, typical generative AI integrations accept a generic prompt that contains only the transcribed user query and static profile data. The prompt construction process does not systematically encode multimodal emotional signals, time-series state information, or user-specific dialogue history in a structured way. Consequently, the generative AI model cannot reliably adjust the level of detail, tone, and focus of the response according to the current stress or anxiety level of the user or subject. From a computer-technology standpoint, the processing pipeline does not provide a technical mechanism for fusing multimodal inputs into prompt sentences and display/speech control parameters in a manner that improves system responsiveness, robustness, and human-machine interaction efficiency.

In addition, conventional display control on head-mounted or see-through displays often uses static overlays or simple context menus that do not leverage real-time gaze tracking to adapt emphasis or layout. The processor typically renders all information with similar priority, regardless of which element the user is actually viewing. This can result in visual clutter, increased cognitive burden, and inefficient use of limited display real estate. There is no integrated control logic that ties emotional state estimation, generative response content, and gaze-based emphasis into a single coordinated control flow.

Accordingly, there is a need for an improved computer-implemented system and processing architecture in which a processor is specifically configured to: (i) perform multimodal emotion estimation from audio, image, and biometric inputs; (ii) construct structured prompt sentences for a generative AI model by combining intent, subject state, and emotional state; and (iii) generate display and voice-synthesis control information that dynamically adjusts information density, layout, and speech parameters, including gaze-based emphasis. Such a configuration would improve the operation of computers implementing interactive support systems by reducing redundant processing, lowering user decision-making load, and enabling more efficient and context-aware human-computer interaction, particularly in high-stress or high-anxiety environments.

The specific processing by the specific processing unit 290 of the data processing device 12 in Application Example 2 is realized by the following means.

The present invention provides a server comprising a processor configured to analyze input voice signals obtained from an audio input/output unit to extract speech-recognition features and convert audio data into character-string data based on the extracted features; perform natural language processing on the character-string data to extract a user utterance intent and associated target information, acquire state information of a subject stored in a storage device, and generate context information based on the utterance intent, the associated target information, and the state information; preprocess image data and biometric information acquired from an imaging device and a biological measurement device, and estimate emotional states of a user and the subject based on facial-expression information, acoustic information, and physiological information included in the preprocessed data; construct, in a natural language, a prompt sentence as a generation input sentence to be input to a generative AI model based on the utterance intent, the context information, and the emotional states, and input the prompt sentence to the generative AI model to generate a response sentence; generate display control information and voice-synthesis control information that specify display items, information amount, display position, emphasis-display conditions, voice output tone, and speech rate, based on the response sentence and the emotional states, and transmit the display control information and the voice-synthesis control information to a display unit and the audio input/output unit; and control the display unit to superimpose information based on the response sentence in a field of view of the user and emphasize information corresponding to a gaze region based on gaze information obtained from a gaze detection device, and control the audio input/output unit to execute voice-synthesis processing based on the response sentence and the voice-synthesis control information and output synthesized voice. This enables the computer system to integrate multimodal emotion estimation, intent- and state-aware prompt sentence construction for a generative AI model, and adaptive presentation control into a single coordinated processing pipeline, thereby improving computational efficiency, reducing user cognitive load, and enhancing responsiveness and robustness of interactive support in high-stress or high-anxiety situations.

The term “audio input/output unit” refers to a hardware and software component that acquires analog voice signals from a user via a microphone, converts the signals into digital audio data, and outputs synthesized or prerecorded audio to the user via a speaker or equivalent transducer.

The term “character-string data” refers to digital data representing a sequence of characters in a natural language, encoded in a computer-readable format, and obtained by converting recognized speech or other input into text.

The term “natural language processing” refers to a set of computer-implemented algorithms that analyze character-string data to perform at least one of tokenization, part-of-speech tagging, syntactic parsing, semantic analysis, intent classification, and entity extraction.

The term “user utterance intent” refers to a semantic representation of a purpose or request expressed by a user in speech or text, classified into one of a plurality of predefined categories used by the system to guide response generation.

The term “associated target information” refers to information items extracted from user input that are semantically related to the user utterance intent, including but not limited to object identifiers, time expressions, and action parameters.

The term “subject” refers to an individual or entity whose state information is monitored, stored, and used by the system as a basis for generating context-aware responses to the user.

The term “state information” refers to data in a storage device that represents a current or past condition of the subject, including at least one of physiological data, scheduled tasks, environmental conditions, and interaction history.

The term “context information” refers to structured data generated by combining the user utterance intent, the associated target information, and the state information of the subject, and used as an input for prompt construction and response generation.

The term “imaging device” refers to a hardware component such as a camera that captures optical information from a scene, converts the information into digital image data, and supplies the image data to the processor.

The term “biological measurement device” refers to a sensor or group of sensors that measure at least one physiological parameter of a person, such as heart rate, body temperature, respiration rate, or movement, and output corresponding biometric information.

The term “biometric information” refers to digital data representing one or more physiological or behavioral characteristics of a person, obtained from a biological measurement device, and used by the system for emotion estimation or state analysis.

The term “image data” refers to digital data representing a still image or a sequence of images captured by an imaging device, including pixel values and associated metadata.

The term “facial-expression information” refers to features derived from image data corresponding to a face region, which encode at least one of facial muscle configuration, posture, and expression patterns used for emotion estimation.

The term “acoustic information” refers to features derived from audio data, including at least one of spectral characteristics, pitch, energy, and temporal patterns, used for speech or emotion analysis.

The term “physiological information” refers to features derived from biometric information that represent the physiological state of a person, such as heart rate variability, movement level, or temperature trend.

The term “emotional states” refers to a set of values or labels that quantitatively or qualitatively represent psychological conditions of a user or subject, including states such as stress, anxiety, calmness, irritation, or fatigue.

The term “generative AI model” refers to a machine learning model, typically including a neural network trained on large-scale language data, that receives a prompt sentence as input and outputs a generated response sentence in a natural language.

The term “prompt sentence” refers to a natural-language input sentence or sequence of sentences that encodes at least the user utterance intent, the context information, and the emotional states, and is supplied to the generative AI model to guide generation of a response sentence.

The term “response sentence” refers to a natural-language sentence or sequence of sentences generated by the generative AI model in response to a prompt sentence.

The term “display control information” refers to control parameters generated by the processor that define how information is to be visually presented on a display unit, including display items, information amount, display positions, emphasis conditions, and visual styles.

The term “voice-synthesis control information” refers to control parameters generated by the processor that define how text is to be converted into synthesized speech, including at least one of voice type, voice output tone, speech rate, and volume.

The term “display unit” refers to a hardware component that presents visual information to a user, including but not limited to a head-mounted display, a see-through display, or a conventional screen.

The term “gaze detection device” refers to a sensor and processing module that detect a direction of a user's gaze or a region of a display being looked at by the user, based on at least eye images or related signals.

The term “gaze region” refers to a region on a display unit that is determined, based on output from the gaze detection device, to correspond to a position or area currently being looked at by the user.

The term “emphasis-display conditions” refers to rules or parameters that specify when and how particular display items are to be visually emphasized, such as by changing font size, color, brightness, or adding highlighting.

The term “synthesized voice” refers to audio signals generated by a voice-synthesis process from text data, according to the voice-synthesis control information, and output to the user through the audio input/output unit.

The term “time-series state information” refers to state information of the subject that is stored as a sequence of values indexed by time, enabling analysis of trends or changes over time.

The term “emotional-state vectors” refers to numerical vectors whose elements represent quantitative scores corresponding to different emotional states of a user or subject.

According to one embodiment, a system includes a terminal worn or operated by a user and a server communicatively connected to the terminal via a communication network. The terminal includes at least a display unit, an audio input/output unit, an imaging device, a biological measurement device, and a gaze detection device. The server includes at least one processor, a main memory, a non-volatile storage device, and a communication interface, all operating under a server operating system.

The terminal operates under a mobile operating system such as a general-purpose handheld operating system. The terminal includes a system-on-chip having a central processing unit, a graphics processing unit, and a digital signal processor. The terminal includes a microphone and a speaker or bone-conduction transducer in the audio input/output unit, an outward-facing camera in the imaging device, an inward-facing infrared camera in the gaze detection device, and one or more physiological sensors such as a heart-rate sensor and accelerometer in the biological measurement device. The terminal stores a caregiver identifier, a subject identifier, server address information, and an authentication token in local non-volatile memory.

The server operates under a general-purpose server operating system and executes an application server, a speech-recognition engine, a natural language processing library, a multimodal emotion estimation module, and a generative AI model. The server uses a database management system in the storage device to store subject state information, time-series state information, emotional-state vectors, and dialogue histories. The server uses a graphics processing device to accelerate inference of the speech-recognition engine, the emotion estimation module, and the generative AI model.

The server receives digital audio data from the terminal and converts compressed audio frames into waveform data using a speech codec such as a predictive audio codec. The server executes a speech-recognition model implemented as a deep neural network, which may be a self-supervised representation model followed by a sequence-to-sequence decoding network. The server extracts acoustic features such as log-Mel spectral coefficients, normalizes the features using learned statistics, and inputs the features into a neural network comprising multiple convolutional layers and transformer layers. The server decodes a sequence of character tokens or word tokens using a language model and outputs character-string data as text. Because the speech-recognition engine executes on the graphics processing device and uses batched inference on multiple input segments, the server achieves lower latency and higher recognition accuracy compared with rule-based or single-threaded implementations.

The server executes natural language processing on the character-string data using a pretrained bidirectional transformer model. The server tokenizes the text, applies an embedding layer, and feeds the sequence into multiple self-attention layers. The server outputs a distribution over intent classes and identifies tokens corresponding to named entities. The server maps the distribution to a user utterance intent and extracts associated target information such as subject identifiers, time expressions, or object types. The server then accesses subject state information stored in the database, including scheduled tasks, physiological data, and previous interaction records, and constructs context information as a structured record. The server thereby avoids repeated ad-hoc parsing and decision logic and centralizes intent and state derivation in a single model, which reduces branching logic and improves maintainability and computational efficiency.

The server receives image data from the terminal and decodes the image data into pixel values. The server executes a face-detection network on the pixel values and crops facial regions. The server passes the facial regions through a convolutional neural network trained for emotion classification and outputs facial-expression information such as feature vectors in a latent space. The server receives biometric information from the terminal and derives physiological information such as average heart rate, heart rate variability, and movement intensity over defined time windows. The server optionally derives acoustic information such as pitch contours and energy trajectories from audio. The server concatenates or otherwise fuses the facial-expression information, physiological information, and acoustic information into a multimodal feature vector.

The server inputs the multimodal feature vector into an emotion estimation network, which may be a transformer-based encoder or a multilayer perceptron. The server computes emotional-state vectors whose elements represent estimated probabilities or scores for emotional categories such as stress, anxiety, calmness, or fatigue. The server stores the emotional-state vectors as time-series state information in the database. Because the server maintains this multimodal fusion in a trained neural network, it achieves higher robustness to noise, missing modalities, or conflicting cues compared with conventional rule-based threshold logic, thereby improving the accuracy of emotional state recognition.

The server constructs a prompt sentence for a generative AI model by combining the user utterance intent, the context information, and the emotional-state vectors. The server uses a prompt assembly module that applies a deterministic template selection and field insertion process. The server selects a template based on the user utterance intent and inserts fields derived from subject state information and emotional states. For example, when the user utterance intent is a medication schedule query and the subject state information includes a next medication time and drug name, and the emotional-state vectors indicate high anxiety and high stress, the server constructs a prompt sentence such as:

“You are a caregiving support expert AI. The care-recipient currently has high ‘anxiety’, and the caregiver has high ‘stress’. For care-recipient ID 123, the next medication is one tablet of ‘XX’ at 2 p.m. The caregiver asked, ‘When should we take the next medicine?’. First, say one sentence to reassure both the caregiver and the care-recipient. Then, in simple language, succinctly explain the next medication time, the drug name, and only the one or two most important precautions, avoiding technical terms.”

The server encodes the emotional-state vectors into explicit verbal conditions, such as “high stress” or “high anxiety,” and into constraints on tone and length, such as “succinctly explain,” “avoid technical terms,” or “use three short steps.” By embedding these constraints into the prompt sentence, the server configures the generative AI model to perform content selection and phrasing that align with the current state of the user and subject. This approach differs from conventional use of static prompts by making the prompt structure itself an adaptive data structure driven by real-time emotional state and time-series information, thus improving response relevance and reducing unnecessary information.

The server executes the generative AI model on the graphics processing device. The generative AI model includes a transformer-based language model trained on large-scale text data. The server tokenizes the prompt sentence, maps tokens to embeddings, and applies multiple self-attention and feed-forward layers. The server repeatedly computes a probability distribution over a vocabulary for the next token and selects tokens according to a greedy or constrained sampling strategy. The server terminates generation when a special end token is output or when a maximum token count is reached and detokenizes the sequence into a response sentence. The server may apply output filters to remove prohibited phrases, limit sentence count, or normalize style. Because the server uses a shared generative AI model with adaptive prompts instead of many specialized rule-based responders, the server reduces the total number of deployed models and rule sets, which simplifies update management and improves consistency. In addition, running the generative AI model on a graphics processing device with batched decoding reduces average latency per response and stabilizes system throughput.

The server generates display control information and voice-synthesis control information based on the response sentence and the emotional-state vectors. The server parses the response sentence into logical units such as steps, headings, and warnings. The server assigns an importance score to each unit using a lightweight classifier or rule set that favors time expressions, imperative verbs, and explicit warnings. The server then determines display items, display positions, emphasis-display conditions, and font sizes. When the emotional-state vectors indicate high anxiety or high stress, the server sets the number of display items to a small number of high-importance units, increases font size and contrast, and suppresses non-critical information. The server simultaneously sets voice-synthesis control information such as reduced speech rate, moderate pitch, and calm tone. When the emotional-state vectors indicate a normal or low-stress state, the server can allow more comprehensive text and standard visual presentation. Because the server calculates presentation parameters algorithmically from emotional-state vectors and importance scores, the system achieves a consistent and measurable adjustment of information density and modality, improving readability and decreasing user cognitive load.

The terminal receives the display control information and voice-synthesis control information from the server. The terminal renders visual information using a graphical framework such as a compositing engine or an OpenGL-based renderer. The terminal creates overlay elements in the display unit corresponding to the display items and positions them in the user's field of view as specified. The terminal applies font sizes, colors, and highlighting rules according to the emphasis-display conditions. The terminal simultaneously invokes a text-to-speech engine provided by the mobile operating system, passes the response sentence and the voice-synthesis control information, and outputs synthesized voice through the audio input/output unit. The terminal thereby directly controls hardware for image and audio output based on parameters computed by the server, which ties the abstract information processing to specific device control and results in a technical improvement in user interface behavior.

The terminal uses the gaze detection device to obtain gaze information and determines a gaze region on the display unit. The terminal maintains a mapping between display items and their on-screen coordinates. The terminal compares the gaze region with these coordinates and applies emphasis-display conditions (such as font enlargement or outline highlighting) to the display item that is closest to the gaze region. This gaze-driven emphasis reduces the need for manual selection or focus operations, decreases visual search time, and improves the effective utilization of limited display space on head-mounted devices. Because the gaze computation and emphasis update run in a continuous loop with bounded resource usage and a defined update frequency, the terminal provides responsive interaction without significantly increasing power consumption.

The server stores dialogue histories, time-series state information of the subject, and emotional-state vectors in the database. The server references these records in subsequent prompt construction. For example, when the subject has repeatedly exhibited high anxiety during previous similar events, the server can include in the prompt sentence instructions to extend initial reassurance sentences or to further simplify technical terms. Because this adaptation is encoded through structured fields and not ad-hoc business logic, the system improves data management and reuse and allows consistent behavior across instances.

The server may use alternative or additional neural network architectures for speech recognition, emotion estimation, and the generative AI model, such as recurrent networks or convolution-augmented transformers. The server may train these models using supervised, unsupervised, or self-supervised learning on domain-specific datasets. The server may apply error functions such as cross-entropy for classification tasks or sequence-to-sequence loss for transcription tasks, and update weights using gradient-based optimization. The server may augment training data using noise addition, time stretching, or data masking to improve robustness. By designing and training the models with domain-specific augmentation and loss terms, the system achieves higher recognition accuracy and more stable emotion estimation in noisy, real-world environments.

The system can be applied not only to caregiving support but also to other domains where a user requires real-time guidance under cognitive or emotional load, such as industrial maintenance, emergency response, or training scenarios. In each case, the same technical framework applies: the server analyzes multimodal input, constructs a state- and emotion-aware prompt sentence for a generative AI model, and generates presentation parameters for a head-mounted or local display and audio output. The use of adaptive prompts and coordinated display and audio control provides a technical improvement over generic conversational agents and static display systems by optimizing information transmission and reducing misinterpretation under constrained attention.

Because the server and terminal cooperate in a tightly defined data flow using specific data structures for acoustic features, natural language tokens, emotion vectors, prompt sentences, and display control parameters, the system goes beyond mere automation of human judgment. The system reconfigures the underlying computer architecture to handle multimodal information and emotional state as first-class computational entities, thereby improving processing efficiency, reducing communication overhead through controlled data formats and compression, and enhancing the precision and timeliness of information provided to the user.

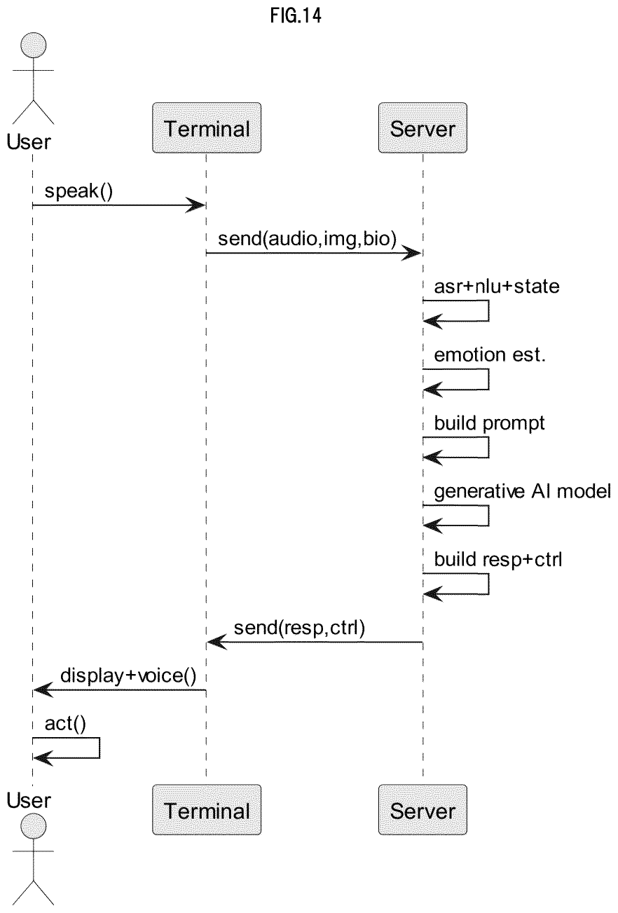

The following describes the processing flow using FIG. 14.

### Step 1:

User activates the terminal and initializes the session.

User powers on the terminal and selects an interaction mode. The input to this step is a user action such as pressing a power button or issuing a wake-word. The terminal reads a caregiver identifier, a subject identifier, server address information, and an authentication token from local non-volatile memory. Based on these inputs, the terminal configures wireless network parameters and prepares a secure communication channel. The output of this step is a set of connection parameters and authentication data stored in terminal memory and used to establish a secure session with the server.

### Step 2:

Terminal establishes a secure communication session with the server.

Terminal sends a connection request including the authentication token and identifiers to the server via a network interface. The input to this step is the connection parameters from Step 1.

Server receives the request, verifies the token against a user database, and, when valid, creates a session record containing the caregiver identifier, subject identifier, and a session identifier.

Server stores this record in a session store and returns a session acknowledgment to the terminal.

The output of this step is an active session context shared between the terminal and the server.

### Step 3:

User provides voice input and terminal acquires raw audio data.

User speaks a natural-language utterance such as “When should we take the next medicine?” or “Tell me what emergency steps to take.” The input to this step is the air-vibration sound produced by the user. Terminal uses a microphone to convert the analog sound into an electrical signal and digitizes the signal using an A/D converter at a specified sampling rate. Terminal stores the resulting PCM samples in an internal buffer. The output of this step is a buffered sequence of raw PCM audio data corresponding to the user utterance.

### Step 4:

Terminal performs local audio preprocessing and compression.

Terminal applies a digital signal processing library to the PCM audio buffer. The input to this step is the raw PCM audio from Step 3. Terminal executes noise suppression, echo cancellation, and automatic gain control by applying filters and adaptive algorithms to the samples, thereby reducing environmental noise and feedback artifacts. Terminal then segments the cleaned audio into fixed-length frames and compresses each frame using an audio codec. The output of this step is a sequence of compressed audio frames together with metadata such as timestamps and session identifiers.

### Step 5:

Terminal captures image data and biometric information.

Terminal activates an outward-facing camera and one or more physiological sensors. The input to this step is optical information from the camera lens and analog sensor readings from devices such as a heart-rate sensor or accelerometer. Terminal converts optical signals into digital image frames using an image signal processor and encodes the frames in a compressed format. Terminal converts analog physiological signals into numerical values and organizes them as timestamped measurements. Terminal may aggregate these measurements into sliding time windows. The output of this step is compressed image data and structured biometric information ready for transmission to the server.

### Step 6:

Terminal acquires gaze information and prepares gaze data.

Terminal uses an inward-facing infrared camera and a gaze detection library to capture eye images. The input to this step is a sequence of eye images acquired at a defined frame rate. Terminal detects pupil positions, estimates eyeball orientation, and computes a gaze direction vector in device coordinates by applying image processing and geometric calculations. Terminal maps each gaze direction vector to display coordinates using a calibration transform. The output of this step is a stream of gaze data records that include timestamps and gaze coordinates on the display.

### Step 7:

Terminal transmits multimodal data to the server.

Terminal packages compressed audio frames, compressed image data, biometric information, and optionally gaze data into one or more network messages. The input to this step is the processed data from Steps 4, 5, and 6, together with session information. Terminal serializes these data into a defined message format and sends them to the server via the secure channel. The output of this step is a set of network messages received at the server and queued for processing.

### Step 8:

Server decodes audio and performs speech recognition.

Server receives compressed audio frames from the terminal. The input to this step is the compressed audio with associated metadata. Server applies the corresponding audio codec decoder to reconstruct PCM audio samples. Server segments the reconstructed audio into utterances using voice activity detection. Server extracts acoustic features such as log-Mel filter bank coefficients and feeds these features into a deep neural network speech-recognition engine. Server runs the neural network to compute token probabilities over time and decodes the most likely token sequence using a language model. The output of this step is character-string data representing the transcribed user utterance.

### Step 9:

Server applies natural language processing to determine intent and entities.

Server inputs the transcribed text from Step 8 into a natural language processing module. The input to this step is the character-string representation of the user utterance. Server tokenizes the text, applies embeddings, and processes the token sequence with a transformer-based model to obtain contextual representations. Server classifies the utterance into a user utterance intent, such as a medication schedule query or emergency response query, and performs entity recognition to extract associated target information such as drug names or time references. The output of this step is a structured representation that includes the user utterance intent and associated target information.

### Step 10:

Server retrieves and organizes subject state information.

Server uses the subject identifier and the structured representation from Step 9 to query a database. The input to this step is the subject identifier and the extracted intent and entities. Server retrieves state information such as medication schedules, recent physiological measurements, and interaction history, and compiles these into a unified context record. Server may convert raw records into normalized values and symbolic labels to simplify subsequent processing. The output of this step is context information that reflects the current and relevant past state of the subject.

### Step 11:

Server decodes image data and extracts facial-expression features.

Server receives compressed image data from the terminal. The input to this step is the encoded image stream. Server decodes each frame into pixel arrays and applies a face detection algorithm to locate faces. Server crops facial regions and resizes them to a standard resolution. Server feeds the cropped images into a convolutional neural network trained to extract facial-expression features. The network outputs feature vectors that encode facial muscle configurations and expression-related patterns. The output of this step is a sequence of facial-expression feature vectors associated with timestamps and identities.

### Step 12:

Server processes biometric information and derives physiological features.

Server receives biometric information from the terminal. The input to this step is time-series sensor data including parameters such as heart rate and motion. Server resamples the time series to a standard grid if necessary and computes physiological features such as average heart rate, heart rate variability, and movement intensity over predefined windows. Server may also compute derivative measures such as acceleration magnitude or trend indicators. The output of this step is a set of numerical physiological feature vectors aligned with time.

### Step 13:

Server fuses multimodal features and estimates emotional states.

Server aligns facial-expression features from Step 11 and physiological features from Step 12 in time. The input to this step is the aligned feature streams, and optionally acoustic features extracted in Step 8. Server concatenates or otherwise combines these features into multimodal vectors and feeds the vectors into an emotion estimation network such as a transformer encoder or multilayer perceptron. Server computes emotional-state vectors whose components represent estimated probabilities or intensities for emotions such as stress, anxiety, calmness, or fatigue. Server compares these values with thresholds to detect high-stress or high-anxiety conditions. The output of this step is a set of emotional-state vectors for the user and the subject.

### Step 14:

Server constructs a prompt sentence for the generative AI model.

Server passes the user utterance intent, associated target information, context information, and emotional-state vectors to a prompt construction module. The input to this step is the combined logical and emotional representation from Steps 9, 10, and 13. Server selects a prompt template based on the user utterance intent and inserts specific values such as subject identifiers, next medication time, drug name, and emotional labels into the template. Server encodes constraints such as desired tone and brevity as explicit instructions in the text. The output of this step is a prompt sentence in natural language that is ready to be provided to the generative AI model.

### Step 15:

Server generates a response sentence using the generative AI model.

Server tokenizes the prompt sentence from Step 14 and supplies the token sequence as input to a transformer-based generative AI model running on a graphics processing device. The input to this step is the tokenized prompt and model parameters. Server computes, for each generation step, a probability distribution over possible next tokens and selects tokens using a decoding strategy such as greedy selection or constrained sampling. Server continues generation until an end marker is produced or a maximum length is reached and then detokenizes the resulting token sequence into natural-language text. The output of this step is a response sentence that semantically addresses the user utterance under the conditions specified in the prompt sentence.

### Step 16:

Server derives presentation structure and extracts key information units.

Server analyzes the response sentence generated in Step 15. The input to this step is the natural-language response text. Server segments the text into units such as individual sentences or labeled steps. Server applies heuristic rules or a lightweight classifier to assign importance scores to each unit, favoring time expressions, direct instructions, and safety warnings. Server creates a hierarchical structure that distinguishes primary items to be displayed prominently from secondary details. The output of this step is a structured representation of the response, including ordered units and importance scores.

### Step 17:

Server generates display control information and voice-synthesis control information.

Server combines the structured response from Step 16 with emotional-state vectors from Step 13. The input to this step is the segmented response, importance scores, and emotional-state data. When high-stress or high-anxiety states are detected, server limits the number of units to a small set of high-importance items, assigns large font sizes and high contrast to these items, and omits less important details. Server also sets voice-synthesis control parameters such as reduced speech rate and a calm tone. When emotional states are normal, server allows more detailed content and standard visual styles. The output of this step is a set of display control parameters and voice-synthesis control parameters associated with the response sentence.

### Step 18:

Server transmits response and control information to the terminal.

Server packages the response sentence, display control information, and voice-synthesis control information into a response message. The input to this step is the text and control parameters from Steps 15 and 17. Server serializes these data and sends the message to the terminal via the secure communication channel. The output of this step is a network message queued for processing by the terminal.

### Step 19:

Terminal renders visual information based on display control information.

Terminal receives the response message from the server. The input to this step is the response sentence text and the display control parameters. Terminal parses the control parameters and creates graphical elements for each display item. Terminal positions these elements within the display unit according to specified coordinates and applies the specified font sizes, colors, and highlighting rules. Terminal then draws the elements into an overlay visible to the user. The output of this step is a rendered visual interface containing the key response information in the user's field of view.

### Step 20:

Terminal synthesizes and outputs voice based on voice-synthesis control information.

Terminal extracts the response sentence and voice-synthesis control parameters from the response message. The input to this step is the text and audio control parameters. Terminal invokes a text-to-speech engine, supplies the text, and configures the engine with the specified speech rate, pitch, and volume. The engine produces PCM audio data representing synthesized speech. Terminal sends the synthesized audio to the speaker or bone-conduction transducer in the audio input/output unit. The output of this step is an audible playback of the response sentence for the user.

### Step 21:

Terminal applies gaze-based emphasis to displayed information.

Terminal reads current gaze data from the gaze detection device. The input to this step is the gaze coordinates on the display and a list of display element locations from Step 19. Terminal computes, for each display element, a distance between its central coordinates and the gaze coordinates and selects the element with the smallest distance below a threshold as the focused element. Terminal modifies the style properties of the focused element, such as increasing font size or adding a highlight border, and instructs the rendering engine to redraw the overlay. The output of this step is an updated visual display in which the information corresponding to the user's gaze region is emphasized.

### Step 22:

User observes and follows the presented instructions.

User receives the visual and auditory information produced in Steps 19, 20, and 21. The input to this step is the displayed guidance and spoken instructions. User interprets the information and performs real-world actions such as preparing a medication at a specified time or executing emergency steps in a defined order. The output of this step is a change in the physical state of the environment and the subject, such as successful medication administration or mitigation of an emergency, which in turn can be sensed in subsequent cycles by the terminal and server for further processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

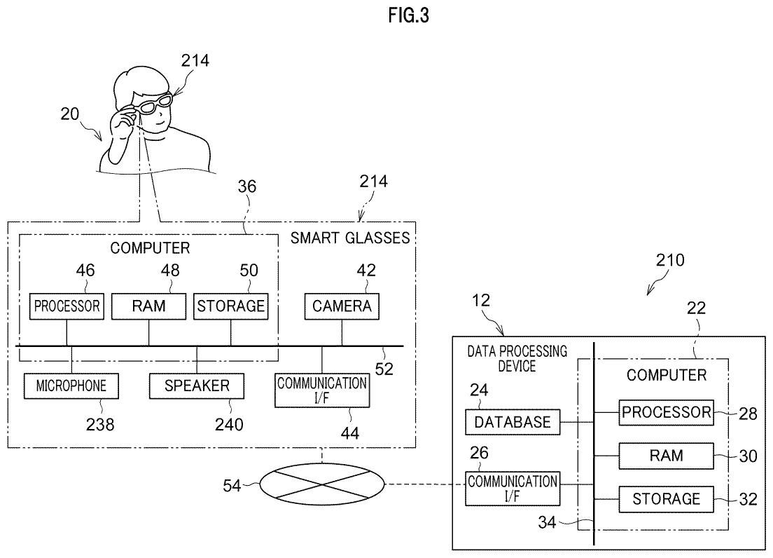

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

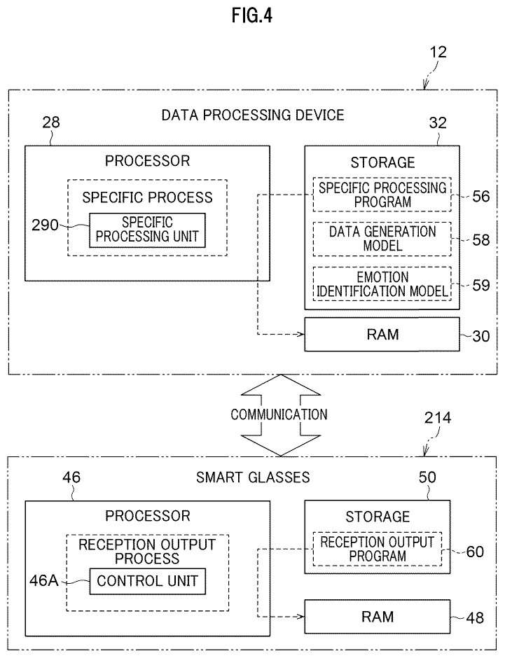

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

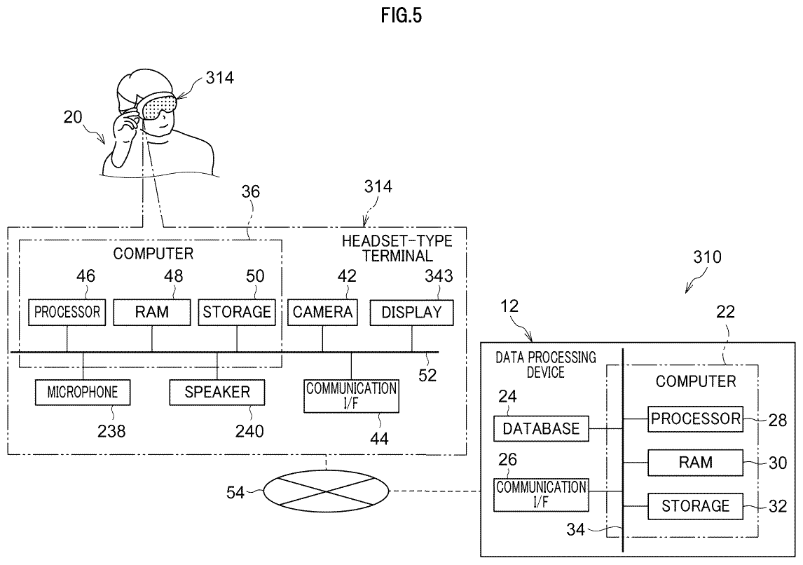

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

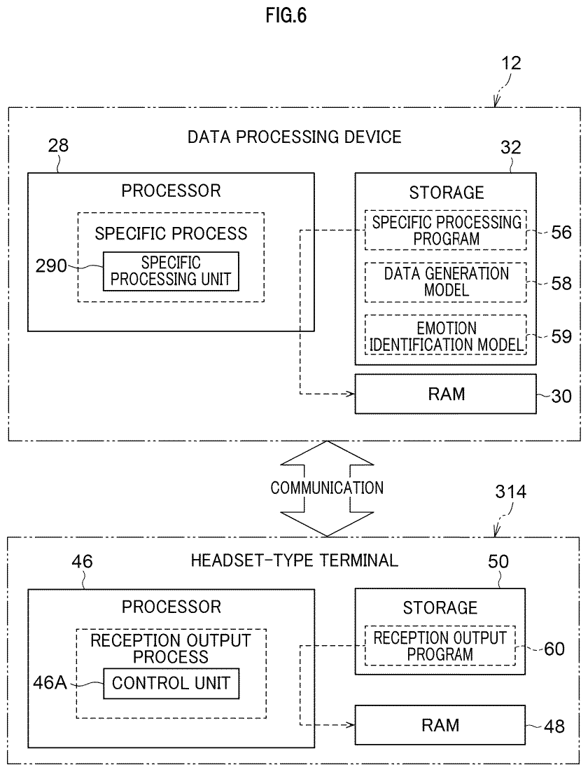

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

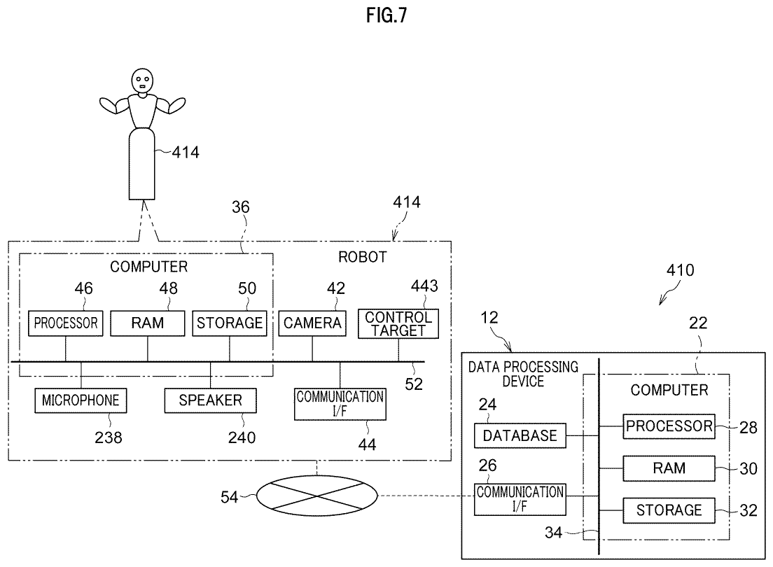

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

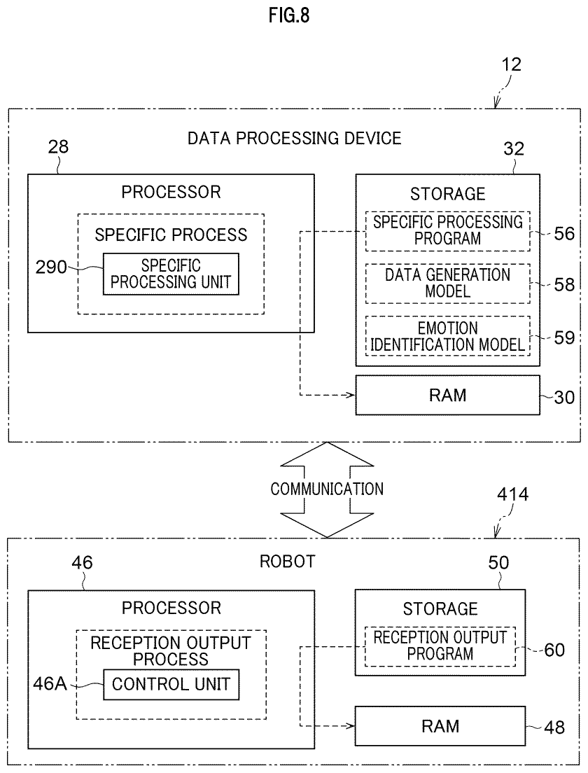

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

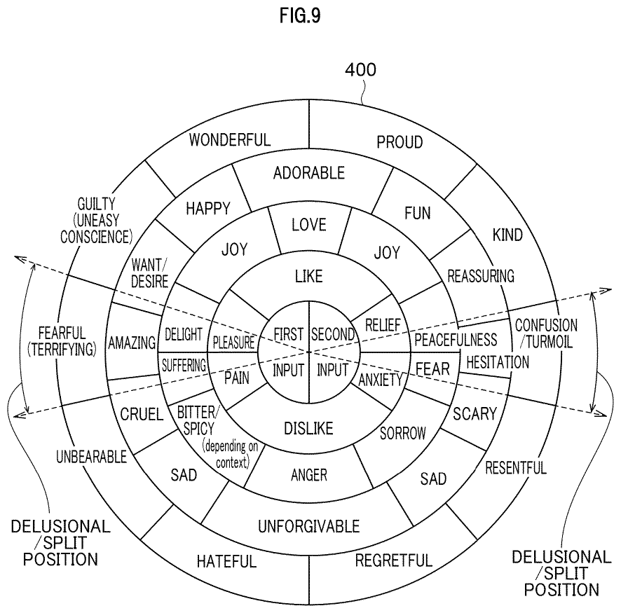

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

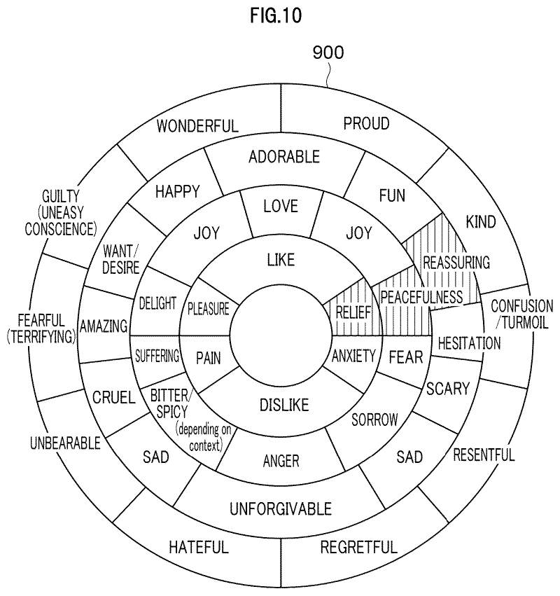

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a display device configured to superimpose information on a field of view of a user, an acoustic device configured to acquire voice of the user and output voice response, a position detection device, a gaze detection device, and an external information acquisition device,
wherein the processor is configured to convert an audio signal acquired from the acoustic device into character information and perform natural language processing on the character information to analyze content of utterance of the user,
wherein the processor is configured to generate, based on an analysis result of the utterance and usage state information acquired from the display device, the position detection device, and the gaze detection device, a prompt sentence to be input to a generative artificial intelligence model, and to request the generative artificial intelligence model to execute response generation processing using the prompt sentence,
wherein the processor is configured to perform post-processing on response information output from the generative artificial intelligence model and environment information acquired from the external information acquisition device by dividing the response information into information for audio output and information for visual output and generating structured display control data,
wherein the processor is configured to cause the display device to perform an augmented-reality display in which information corresponding to an object gazed at by the user is displayed in a manner different from other information and is spatially arranged in association with the environment information, based on the display control data and a gaze position detected by the gaze detection device, and
wherein the processor is configured to record the response information, the gaze position, and the environment information as interaction history and to update generation conditions of the prompt sentence and the display control data based on the interaction history.

### (Supplementary 2)

The system according to supplementary 1,
wherein the processor is configured to estimate an intention and an object of interest of the user based on the character information obtained from the audio signal, the interaction history, and the usage state information, and to add context information including the estimation result to the prompt sentence to be input to the generative artificial intelligence model so as to control response generation by the generative artificial intelligence model in accordance with a preference and a behavior tendency of the user.

### (Supplementary 3)

The system according to supplementary 1,
wherein the processor is configured to associate position information and spatial structure information included in the environment information with information on a group of candidate objects obtained from the generative artificial intelligence model, and to generate the display control data such that detailed information related to a candidate object gazed at by the user is sequentially additionally displayed or switched in the augmented-reality display based on a correspondence relationship between a display position on the display device and the gaze position.

### Application Example 1

### (Supplementary 1)

A system comprising a processor,
wherein the processor is configured to
control a display unit that has a function of superimposing information on a field of view of a user, and an audio input/output unit that has a function of acquiring audio input from the user and providing audio output to the user, and an artificial intelligence processing unit, and
convert audio data acquired from the user by the audio input/output unit into character data and perform natural language processing on the character data to analyze an intention of the user, and generate a prompt sentence to be input to a generative artificial intelligence model on the basis of the analyzed intention of the user and context information including attribute information of a subject person, biological information of the subject person, behavioral history information of the subject person, and medical-related information of the subject person, and
transmit the generated prompt sentence to the generative artificial intelligence model and acquire a response sentence from the generative artificial intelligence model, and
generate response information to be presented to the user on the basis of the acquired response sentence, and transmit the response information as audio output to the audio input/output unit and output the response information as character information and graphic information to the display unit, and
acquire biological information of the subject person, detect an abnormal state on the basis of the biological information, and output warning information corresponding to the abnormal state to the display unit and the audio input/output unit, and
detect a gaze direction of the user, emphasize information corresponding to a display region that the user is gazing at, and control generation of the prompt sentence such that additional information related to the gazed information is included in the prompt sentence for the generative artificial intelligence model, and
transmit the biological information of the subject person and related information to a medical-related organization on the basis of the detected abnormal state or on the basis of a gaze target of the user, acquire instruction information from the medical-related organization, and present the instruction information to the user via the response information.

### (Supplementary 2)

The system according to supplementary 1,
wherein the processor is configured to
refer to a storage unit that stores character data obtained from the audio input of the user, past interaction history accumulated for each subject person, past biological information history, past behavioral history, and past warning history, and generate, by combining template information with the context information, the prompt sentence for the generative artificial intelligence model so as to cause the generative artificial intelligence model to generate at least one of a care plan for the subject person, a meal plan, an exercise plan, an emergency response procedure, an explanatory text, and another action instruction.

### (Supplementary 3)

The system according to supplementary 1,
wherein the processor is configured to
detect that the gaze direction of the user is directed to a specific object or display element for a predetermined time or longer, notify the prompt sentence generation control of identification information corresponding to the specific object or display element, generate the prompt sentence including the identification information, cause the generative artificial intelligence model to output explanatory information or caution information relating to the specific object or display element, and cause the response information to superimpose and display the explanatory information or the caution information on the display unit and to output the explanatory information or the caution information as audio from the audio input/output unit.

### Example 2

### (Supplementary 1)

A system comprising a processor,
wherein the processor is configured to
control a display unit configured as a head-mounted display including a transmissive or semi-transmissive display section that overlays character information and image information in a user's field of view, and control an audio input/output unit including an audio input section configured to acquire speech of the user and an audio output section configured to present synthesized audio to the user, and control a gaze detection unit configured to capture an eyeball of the user and a head posture of the user and detect a gaze direction and a fixation position by image processing, and calculate a fixation time and a gaze movement pattern based on temporal changes of the gaze direction, and communicate with a remote computing resource via a network;
wherein the processor is further configured to execute a speech recognition process including acoustic feature extraction processing and a language model processing on audio data received from the audio input/output unit via the communication with the remote computing resource, and generate text data corresponding to the audio data;
wherein the processor is further configured to estimate an emotional state of the user indicated by an emotion label or a continuous value based on at least one of an acoustic feature extracted from audio data of the user, the text data generated by the speech recognition process, and gaze information acquired by the gaze detection unit;
wherein the processor is further configured to obtain history information related to the user and position information indicating a position of the user, and generate a prompt sentence to be input to a generative artificial intelligence model, based on the text data, the history information, the position information, and the estimated emotional state of the user, the processor being configured to tokenize the prompt sentence and input the tokenized prompt sentence to the generative artificial intelligence model, and generate an answer text corresponding to the prompt sentence by autoregressive decoding; and
wherein the processor is further configured to control an information presentation format based on the answer text and the emotional state of the user, the information presentation format including at least a display position, a display size, and a folded or expanded state of summary information and detailed information on the display unit, and including at least a speaking rate and a voice quality of the audio output by the audio input/output unit.

### (Supplementary 2)

The system according to supplementary 1,
wherein the processor is configured to perform the estimating of the emotional state of the user by executing a first emotion estimation unit configured to perform a first emotion estimation based on at least one of pitch, volume, speaking rate, and spectral features extracted from the audio data, and a second emotion estimation unit configured to perform an emotion analysis on the text data using a natural language processing model, and a third emotion estimation unit configured to estimate at least one of a degree of interest, a degree of hesitation, and a degree of concentration based on at least one of a fixation time, a gaze movement pattern, and a gaze staying position included in the gaze information, and an integrated emotion estimation unit configured to integrate outputs of the first emotion estimation unit, the second emotion estimation unit, and the third emotion estimation unit, and determine a comprehensive emotional state of the user.

### (Supplementary 3)

The system according to supplementary 1,
wherein the processor is configured, when the integrated emotion estimation unit determines that the user is in a fatigue state or a confusion state, to emphasize a summary portion in the answer text in a region near a center of the field of view of the display unit, display a detailed portion in a folded state, and set the speaking rate of the audio output by the audio input/output unit to a lower speed, and when the integrated emotion estimation unit determines that at least one of an interest and a curiosity of the user is high, to expand and display detailed information and related information in the answer text on the display unit, and change the information presentation format such that additional supplementary information is automatically displayed when the gaze detection unit detects that the user's gaze stays on a detailed information region for a time equal to or longer than a predetermined threshold.

### Application Example 2

### (Supplementary 1)

A system comprising a processor,
wherein the processor is configured to
analyze an input voice signal obtained from an audio input/output unit to extract speech-recognition features and convert audio data into character-string data based on the extracted features,
perform natural language processing on the character-string data to extract a user utterance intent and associated target information, acquire state information of a subject stored in a storage device, and generate context information based on the utterance intent, the associated target information, and the state information,
preprocess image data and biometric information acquired from an imaging device and a biological measurement device, and estimate emotional states of a user and the subject based on facial-expression information, acoustic information, and physiological information included in the preprocessed data,
construct, in a natural language, a prompt sentence as a generation input sentence to be input to a generative AI model based on the utterance intent, the context information, and the emotional states, and input the prompt sentence to the generative AI model to generate a response sentence, generate display control information and voice-synthesis control information that specify display items, information amount, display position, emphasis-display conditions, voice output tone, and speech rate, based on the response sentence and the emotional states, and transmit the display control information and the voice-synthesis control information to a display unit and the audio input/output unit,
superimpose, by controlling the display unit, information based on the response sentence in a field of view of the user, and emphasize information corresponding to a gaze region based on gaze information obtained from a gaze detection device, and
execute voice-synthesis processing based on the response sentence and the voice-synthesis control information, and output synthesized voice to the user via the audio input/output unit.

### (Supplementary 2)

The system according to supplementary 1,
wherein the processor is configured to
store, in the storage device, a past dialogue history of the user, time-series state information of the subject, and emotional-state vectors, and, when constructing the prompt sentence, refer to the stored information so as to dynamically change conditions, explanation level, and tone of the prompt sentence in accordance with attributes of the subject, progress status, and emotional changes, thereby individualizing and simplifying the response sentence generated by the generative AI model.

### (Supplementary 3)

The system according to supplementary 1,
wherein the processor is configured to
limit, when the emotional-state estimation indicates that the user or the subject is in a high-stress state or a high-anxiety state, information items to be presented in the display control information to a small number of highly important items, increase font size and display contrast, and, in the voice-synthesis control information, reduce the speech rate and specify a voice tone that provides reassurance, thereby simplifying content and presentation format of the response sentence generated by the generative AI model and reducing a decision-making load of the user.

What is claimed is:

1. A system comprising:
circuitry configured to:
receive, via a communication interface coupled to a packet-switched network, audio data from a wearable terminal device equipped with a display unit and an imaging sensor;
convert the audio data into text data and analyze the text data to determine a query intent;
generate response data based on the query intent; and
transmit the response data to the wearable terminal device via the communication interface for output as at least one of synthesized audio and display data superimposed on a field of view of a user via the display unit.

2. The system according to claim 1, wherein the circuitry converts the audio data into the text data using a speech recognition model and analyzes the text data using a natural language processing model to determine the query intent.

3. The system according to claim 2, wherein the circuitry constructs a prompt data structure encoding the text data, dialog history data stored in a storage device, and user preference data, and transmits the prompt data structure to a generative neural network model comprising a transformer-based architecture with a plurality of self-attention layers to generate the response data.

4. The system according to claim 3, wherein the circuitry updates the dialog history data after each interaction and maintains contextual continuity across a plurality of dialog exchanges within a session, enabling the user to issue follow-up queries without re-specifying context.

5. The system according to claim 4, wherein the circuitry analyzes the user preference data including past interaction patterns and topic frequency data to personalize the response data by adjusting vocabulary complexity and response detail level.

6. The system according to claim 1, wherein the circuitry converts the response data into the synthesized audio using a speech synthesis model with prosodic parameters adjusted based on an estimated ambient noise level derived from the audio data.

7. The system according to claim 1, wherein the circuitry receives gaze tracking data from the wearable terminal device indicating a gaze direction of the user, and adjusts the display data to emphasize information elements aligned with the detected gaze direction.

8. The system according to claim 7, wherein the circuitry receives image data captured by the imaging sensor of the wearable terminal device, performs object recognition on the image data using a convolutional neural network, and generates contextual information data associated with recognized objects for inclusion in the display data.

9. The system according to claim 8, wherein the circuitry combines the recognized object data with the gaze tracking data to determine which objects the user is focusing on, and constructs a prompt data structure encoding the recognized object information and the user query to generate context-aware response data.

10. The system according to claim 1, wherein the circuitry receives environmental sensor data from the wearable terminal device including at least one of ambient light level, temperature, and location data, and adapts the display data format based on the environmental sensor data.

11. The system according to claim 10, wherein the circuitry adjusts display brightness and contrast of the superimposed display data based on the ambient light level, and adjusts font size of text information based on estimated viewing distance derived from imaging sensor data.

12. The system according to claim 11, wherein the circuitry retrieves location-relevant information from external data sources based on the location data, and includes the location-relevant information in the display data as augmented reality annotations overlaid on the field of view.

13. The system according to claim 1, wherein the circuitry performs real-time translation of the text data from a detected source language to a target language specified in user settings, and generates the response data in the target language.

14. The system according to claim 13, wherein the circuitry simultaneously generates translated text for display on the display unit and translated synthesized audio for output, enabling dual-modality multilingual interaction.

15. The system according to claim 1, wherein the circuitry is further configured to detect gesture input data from the imaging sensor of the wearable terminal device, and to process the gesture input data as supplemental input alongside the audio data for determining the query intent.

16. The system according to claim 15, wherein the circuitry maps detected gestures to predefined command identifiers stored in a storage device, and executes corresponding actions including scrolling display content, confirming selections, and dismissing notifications.

17. The system according to claim 1, wherein the circuitry estimates a cognitive load of the user based on speech hesitation patterns and query complexity metrics extracted from the text data, and adjusts an information density of the display data based on the estimated cognitive load.

18. A system comprising:
circuitry configured to:
receive, via a communication interface coupled to a packet-switched network, audio data, gaze tracking data, and image data from a wearable terminal device equipped with a display unit and an imaging sensor;
convert the audio data into text data using a speech recognition model and analyze the text data using a natural language processing model to determine a query intent;
perform object recognition on the image data using a convolutional neural network and combine recognized object data with the gaze tracking data to generate context-aware information;
generate response data by constructing a prompt data structure encoding the query intent, dialog history data, and context-aware information and transmitting to a generative neural network model comprising a transformer architecture with a plurality of self-attention layers;
estimate a cognitive load of a user based on speech hesitation patterns and adjust an information density of display data based on the estimated cognitive load; and
transmit the response data to the wearable terminal device via the communication interface for output as synthesized audio and display data superimposed on a field of view of the user.

19. The system according to claim 18, wherein the circuitry is further configured to perform real-time translation from a detected source language to a target language and to generate dual-modality multilingual output.

20. A method performed by circuitry of a server coupled to a packet-switched network via a communication interface, the method comprising:
receiving, via the communication interface, audio data from a wearable terminal device equipped with a display unit and an imaging sensor;
converting the audio data into text data and analyzing the text data to determine a query intent;
generating response data based on the query intent; and
transmitting the response data to the wearable terminal device via the communication interface for output as at least one of synthesized audio and display data superimposed on a field of view of a user via the display unit.
